(19) United States
(12) Patent Application Publication
(10) Pub. No.: US 2024/0142960 A1
(43) Pub. Date: May 2, 2024

(54) AUTOMATED SIMULATION METHOD BASED ON DATABASE IN SEMICONDUCTOR DESIGN PROCESS, AUTOMATED SIMULATION GENERATION DEVICE AND SEMICONDUCTOR DESIGN AUTOMATION SYSTEM PERFORMING THE SAME, AND MANUFACTURING METHOD OF SEMICONDUCTOR DEVICE USING THE SAME

(71) Applicant: SAMSUNG ELECTRONICS CO., LTD., SUWON-SI (KR)

(72) Inventors: SONGYI HAN, SUWON-SI (KR); JISEONG DOH, SUWON-SI (KR); JINWOO PARK, SUWON-SI (KR); YERO LEE, SUWON-SI (KR); HYEONKYEONG LEE, SUWON-SI (KR); JAEHOON JEONG, SUWON-SI (KR)

(21) Appl. No.: 18/453,808

(22) Filed: Aug. 22, 2023

(30) Foreign Application Priority Data
Oct. 27, 2022 (KR) 10-2022-0139896

(51) Int. Cl. G05B 19/418

(52) U.S. Cl. CPC G05B 19/41875; G05B 2219/32193; G05B 2219/32368

(57) ABSTRACT

A method for determining suitability of a target receipe set for manufacturing a semiconductor device includes: obtaining a reference recipe set by searching a database based on the target recipe set, the reference recipe set has a similarity with a threshold to the target recipe set; performing deep learning based on the database, the target recipe set and the reference recipe set to predict a probability of defect occurring in the semiconductor device when manufactured using a manufacturing process based on the target recipe set; generating a target script set corresponding to the target recipe set by comparing the target recipe set with the reference recipe set; simulating the manufacturing process of the semiconductor device using the target script set; and determining the suitability of the target recipe set based on the probability of the defect and a result of the simulating of the manufacturing process.

### CROSS-REFERENCE TO RELATED APPLICATION

This U.S. patent application claims priority under 35 USC § 119 to Korean Patent Application No. 10-2022-0139896 filed on Oct. 27, 2022 in the Korean Intellectual Property Office (KIPO), the disclosure of which is incorporated by reference in its entirety herein.

### 1. Technical Field

Example embodiments relate generally to semiconductor integrated circuits, and more particularly to automated simulation methods based on databases in semiconductor design processes, automated simulation generation devices performing the automated simulation methods, semiconductor design automation systems performing the automated simulation methods, and manufacturing methods of semiconductor devices using the automated simulation methods.

### 2. Discussion of Related Art

Semiconductor devices may be manufactured with unintended electrical characteristics due to high integration and miniturization of semiconductors. Technology computer aided design (TCAD) is a category of software tools for designing electronic systems such as integrated circuits and printed circuit boards that may be used to reduce these unintended electrical characteristics. A software tool for performing TCAD may be used to understand electrical phenomena, and/or to reduce experimental costs. The software tool may be used to simulate a semiconductor device, simulate a semiconductor design process, or simulate a circuit of the semiconductor device. However, current software tools do not provide precise product specifications of a semiconductor device.

### SUMMARY

At least one example embodiment of the present disclosure provides an automated simulation method capable of automatically and/or efficiently simulating a semiconductor process model and/or a semiconductor device model in a semiconductor design phase, based on a database in which simulation data and real data are loaded.

At least one example embodiment of the present disclosure provides an automated simulation generation device performing the automated simulation method, and a semiconductor design automation system performing the automated simulation method.

At least one example embodiment of the present disclosure provides a method of manufacturing a semiconductor device using the automated simulation method.

According to an example embodiment, a non-transitory computer readable medium is provided that stores program code for determining suitability of a target receipe set for manufacturing a semiconductor device. The program code, when executed by a processor, causes the processor to obtain a reference recipe set by searching a database based on the target recipe set, the reference recipe set having a similarity within a threshold to the target recipe set; perform deep learning based on the database, the target recipe set and the reference recipe set to predict a probability of a defect occurring in the semiconductor device when manufactured using a manufacturing process based on the target recipe set, generate a target script set corresponding to the target recipe set by comparing the target recipe set with the reference recipe set, simulate the manufacturing process of the semiconductor device using the target script set; and determine the suitability of the target recipe set based on the probability of the defect and a result of the simulate of the manufacturing process.

According to an example embodiment, an automated simulation generation device for determining suitability of a target receipe set for manufacturing a semiconductor device includes a processor and a memory storing a computer program for execution by the processor. The computer program: obtains a reference recipe set by searching a database based on the target recipe set, the reference recipe set having a similarity within a threshold to the target recipe set; performs a deep learning based on the database, the target recipe set and the reference recipe set to predict a probability of a defect occurring in the semiconductor when manufactured using a manufacturing process based on the target receipe set; generates a target script set corresponding to the target recipe set by comparing the target recipe set with the reference recipe set; simulates the manufacturing process of the semiconductor device using the target script set; and determines a suitability of the target recipe set based on the probability of the defect and a result of the simulates of the manufacturing process.

According to an example embodiment, a semiconductor design automation system for automatically designing a semiconductor includes a database and an automated simulation generation device. The automated simulation generation device includes a processor and a memory storing a computer program for execution by the processor. The computer program obtains a reference recipe set by searching a database based on the target recipe set, the reference recipe set having a similarity within a threshold to the target recipe set; performs a deep learning based on the database, the target recipe set and the reference recipe set to predict a probability of a defect occurring in the semiconductor when manufactured using a manufacturing process based on the target receipe set; generates a target script set corresponding to the target recipe set by comparing the target recipe set with the reference recipe set; simulates the manufacturing process of the semiconductor device using the target script set; and determines a suitability of the target recipe set based on the probability of the defect and a result of the simulates of the manufacturing process.

According to an example embodiment, a method of manufacturing a semiconductor device includes performing a simulation method associated with the semiconductor device and fabricating the semiconductor device based on a result of the performing of the simulation method. The performing of the simulation method includes: obtaining a reference recipe set by searching a database based on a target recipe set, the reference recipe set having a similarity within a threshold to the target recipe set; performing a deep learning based on the database, the target recipe set and the reference recipe set to predict a probability of a defect occurring in the semiconductor when manufactured using a manufacturing process based on the target recipe set; generating a target script set corresponding to the target recipe set by comparing the target recipe set with the reference recipe set; simulating the manufacturing process of the semiconductor using the target script set; and determining a suitability of the target recipe set based on the probability of the defect and a result of the simulating of the manufacturing process.

In the automated simulation method, the automated simulation generation device, the semiconductor design automation system and the manufacturing method according to example embodiments, when at least one of the manufacturing schemes and the manufacturing order is changed in a research and development (R&D) phase, a verification may be performed automatically using the database, and thus defects may be prevented more accurately and predictably. Accordingly, the defects may be detected consistently and early by allowing the system to automatically perform tasks, the risk of defect may be objectively confirmed by the automated simulation using the database and by the deep learning, and the accuracy of the simulation may be maintained by continuously updating the database.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating an automated simulation method according to an example embodiment.

FIGS. 2 and 3 are block diagrams illustrating an automated simulation generation device according to an example embodiment.

FIG. 4 is a flowchart illustrating an example of obtaining a reference recipe set in FIG. 1.

FIG. 5 is a block diagram illustrating an example of a similarity analysis module included in an automated simulation generation device of FIG. 2.

FIGS. 6A and 6B are diagrams illustrating examples of a target recipe set and a reference recipe set that are obtained by operations of FIGS. 4 and 5.

FIG. 7 is a flowchart illustrating an example of predicting a probability of defects in FIG. 1.

FIG. 8 is a block diagram illustrating an example of a deep learning module included in an automated simulation generation device of FIG. 2.

FIGS. 9A, 9B, 9C and 9D are diagrams illustrating examples of a neural network associated with a deep learning model that is trained and generated by a deep learning module of FIG. 8.

FIG. 10 is a flowchart illustrating an example of automatically generating a target script set in FIG. 1.

FIG. 11 is a block diagram illustrating an example of an automated script generation module included in an automated simulation generation device of FIG. 2.

FIGS. 12A, 12B and 12C are flowcharts illustrating examples of obtaining a target script set in FIG. 10.

FIG. 13 is a diagram for describing operations of FIGS. 12A, 12B and 12C.

FIGS. 14, 15, 16 and 17 are diagrams illustrating examples of automatically generating a target script set in FIG. 10.

FIG. 18 is a flowchart illustrating an example of checking a suitability of a target recipe set in FIG. 1.

FIG. 19 is a block diagram illustrating an example of an automated simulation module included in an automated simulation generation device of FIG. 2.

FIGS. 20, 21, 22 and 23 are flowcharts illustrating an automated simulation method according to an example embodiment.

FIG. 24 is a block diagram illustrating an example of a deep learning module included in an automated simulation generation device of FIG. 2.

FIG. 25 is a flowchart illustrating an automated simulation method according to an example embodiment.

FIGS. 26 and 27 are block diagrams illustrating a semiconductor design automation system according to an example embodiment.

FIGS. 28 and 29 are diagrams illustrating an example of first and second graphic user interfaces included in a semiconductor design automation system of FIG. 27.

FIG. 30 is a block diagram illustrating an example of a visualization unit included in a second graphic user interface of FIG. 29.

FIG. 31 is a flowchart illustrating a manufacturing method of a semiconductor device according to an example embodiment.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

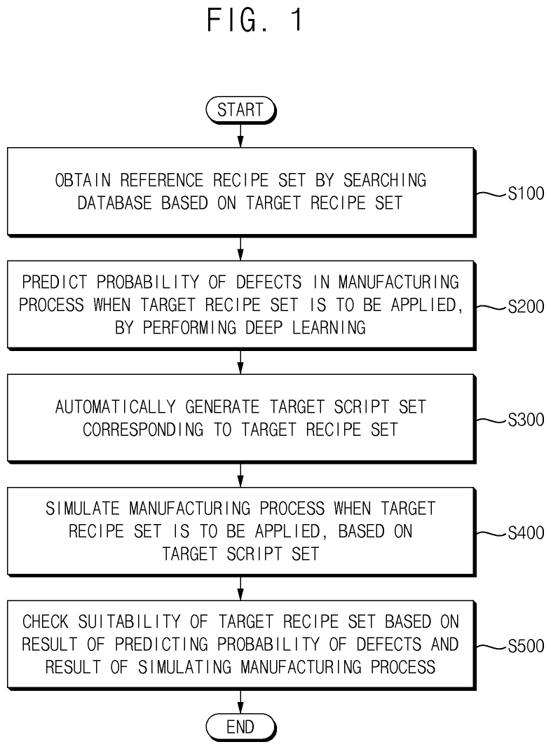

FIG. 1 is a flowchart illustrating an automated simulation method according to an example embodiment.

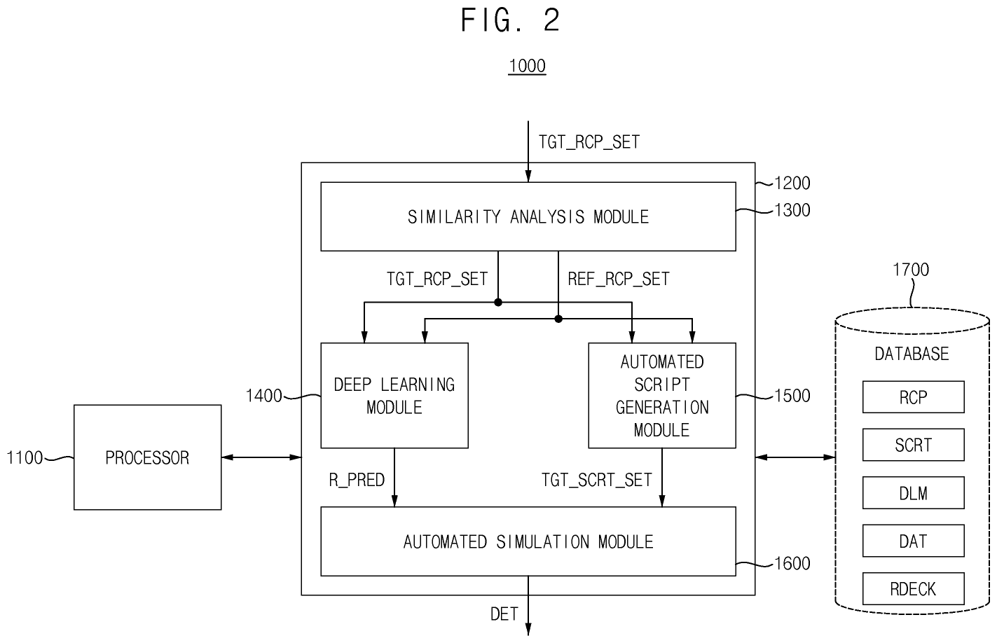

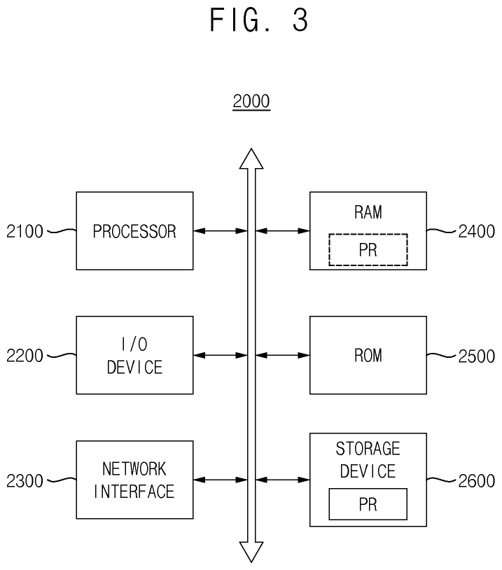

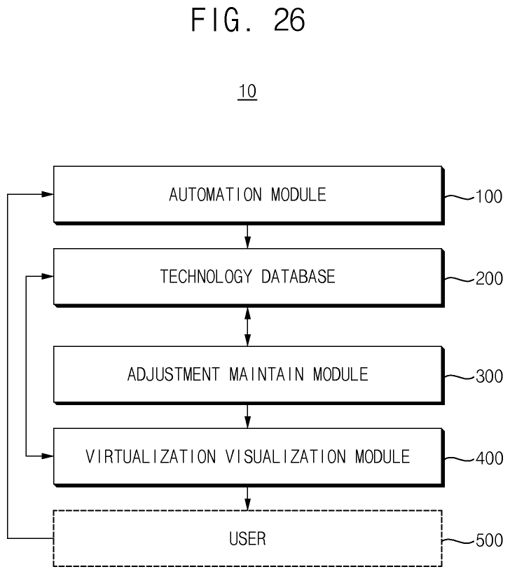

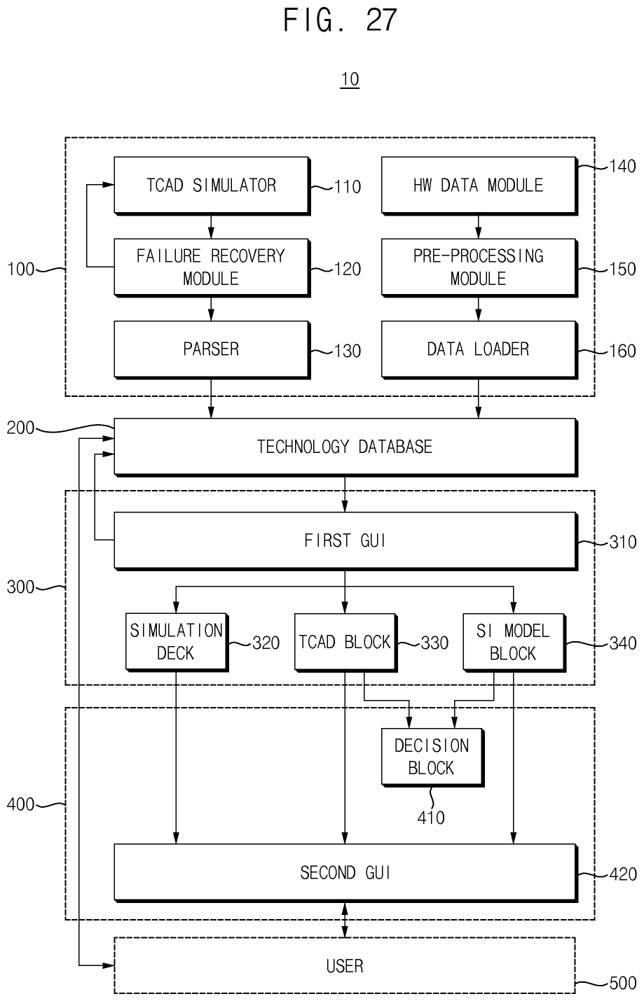

Referring to FIG. 1, an automated simulation method according to an example embodiment may be performed in a semiconductor design phase or during a design procedure of a semiconductor device (or semiconductor integrated circuit). For example, the automated simulation method according to an example embodiment may be performed for a simulation on a semiconductor process model and/or a semiconductor device model in the semiconductor design phase, and may be performed in an automated simulation generation device, a semiconductor design automation system and/or a tool for designing the semiconductor device. For example, a target of the simulation may be at least one condition of a manufacturing process of the semiconductor device and characteristic of the semiconductor device. For example, the automated simulation generation device, the semiconductor design automation system and/or the tool for designing the semiconductor device may include a program (or program code) that includes a plurality of instructions executed by at least one processor. The automated simulation generation device will be described with reference to FIGS. 2 and 3, and the semiconductor design automation system will be described with reference to FIGS. 26 and 27.

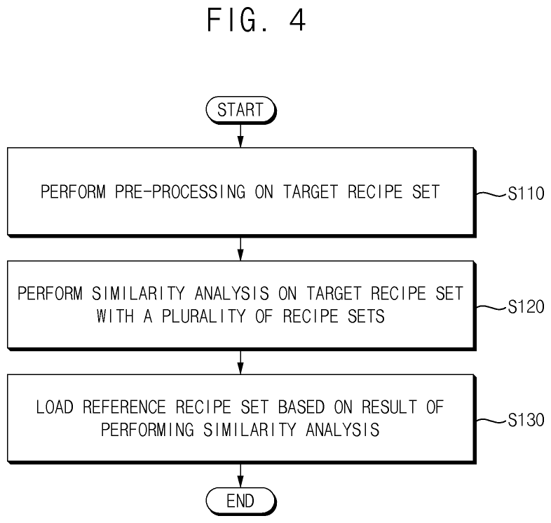

In the automated simulation method according to an example embodiment, a reference recipe set is obtained by searching a database based on a target recipe set for manufacturing a semiconductor device (operation S100). In an embodiment, the target recipe set defines a manufacturing scheme (or method) and a manufacturing order (or sequence) of the semiconductor device. For example, the manufacturing scheme may indicate steps used to manufacture the semiconductor device and the manufacturing order may indicate the order in which these steps are to be performed. In an embodiment, the reference recipe set has the highest similarity to the target recipe set. For example, the reference recipe set may have a similarity within a threshold to the target recipe set. For example, if there are several recipe sets available for manufacturing a particular semiconductor device, one of the several that is most similar to the target recipe set for manufacturing the same particular semiconductor device could be selected as the reference recipe set. Each recipe set may be associated with or related to the manufacturing process of the semiconductor device, may include a plurality of recipes, and may represent manufacturing schemes and a manufacturing order of the semiconductor device that are applied or used in a real manufacturing process. For example, the manufacturing schemes and order may be represented by a combination of the plurality of recipes. Operation S100 will be described with reference to FIG. 4.

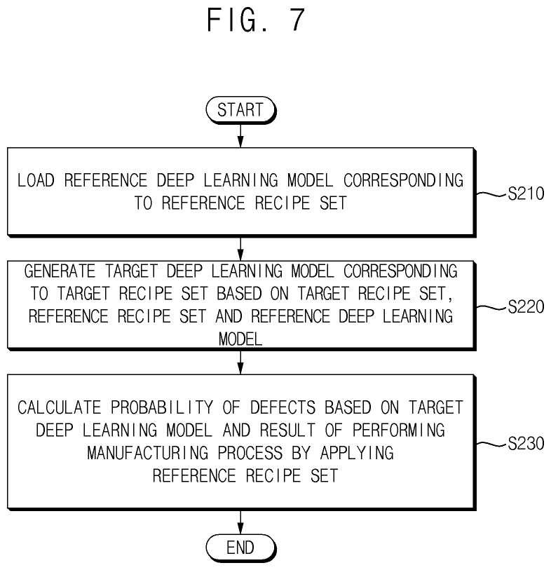

A probability of one or more defects in the manufacturing process of the semiconductor device when the target recipe set is to be applied to the manufacturing process is predicted by performing a deep learning based on the database, the target recipe set and the reference recipe set (operation S200). However, example embodiments are not limited thereto. For example, operation S200 may be performed using a general machine learning rather than the deep learning. For example, the defects may represent failures and/or errors expected to occur when the target recipe set is applied to the manufacturing process. The probability of defects may be referred to as a defect rate or a failure rate. Operation S200 will be described with reference to FIG. 7.

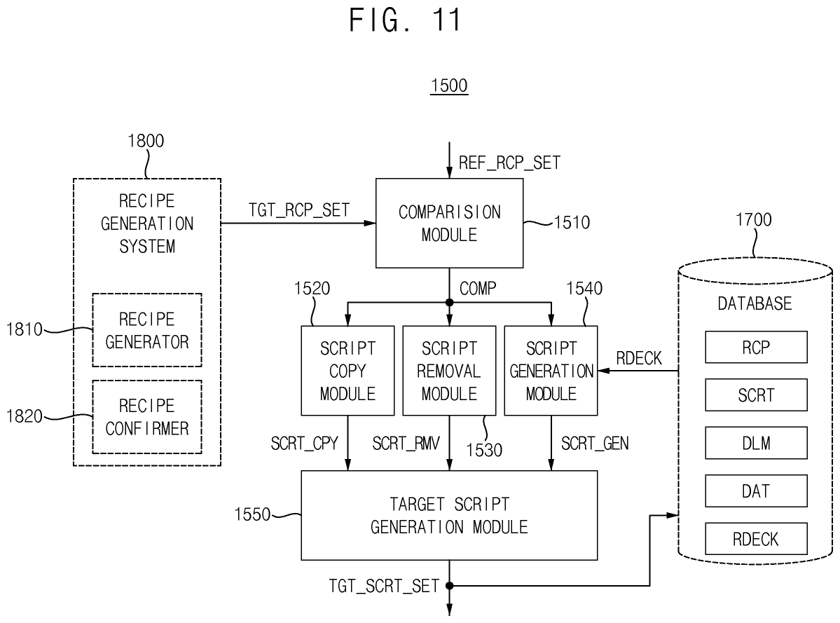

A target script set corresponding to the target recipe set is automatically generated by comparing the target recipe set with the reference recipe set (operation S300). Similarly to each recipe set, each script set may be associated with or related to the manufacturing process of the semiconductor device, may include a plurality of scripts, and may represent manufacturing schemes and a manufacturing order of the semiconductor device in a simulation environment. In other words, a recipe (or a set of recipes) may represent manufacturing conditions in the real world, and a script (or a set of scripts) may be a concept corresponding to the recipe and may represent manufacturing conditions in the simulation environment. Operation S300 will be described with reference to FIG. 10.

The manufacturing process of the semiconductor device when the target recipe set is to be applied to the manufacturing process is simulated based on the target script set (operation S400). For example, the manufacturing process of the semiconductor device may be simulated using the target script set. For example, the simulation in S400 may be performed based on a technology computer aided design (TCAD) or software that performs the TCAD. TCAD simulation is a technique that reproduces a three-dimensional (3D) structure of a transistor by simulating a semiconductor process or semiconductor device, and that predicts the performance and defect rate of semiconductor devices in a layout design stage to reduce development time and cost.

A suitability of the target recipe set is checked (or determined) based on a result of predicting the probability of the defects and a result of simulating the manufacturing process (operation S500). For example, the suitability may be determined based on the probability and the result of the simulating. For example, it may be determined whether the target recipe set is suitable or appropriate for the manufacturing process. Based on a result of checking or determining the suitability of the target recipe set, the manufacturing process to which the target recipe set is applied may be performed, or the target recipe set may be changed. Operation S500 will be described with reference to FIG. 18.

In an example embodiment, the reference recipe set may be a recipe set that has already been applied to the manufacturing process of the semiconductor device, and the target recipe set may be a recipe set that has not yet been applied to the manufacturing process of the semiconductor device and is to be newly applied to the manufacturing process of the semiconductor device. In other words, the suitability of the recipe set which is not used yet may be checked or determined using the recipe set which was already or previously used to manufacture the semiconductor device.

When at least one of the manufacturing schemes and the manufacturing order is changed in a research and development (R&D) phase, verification is performed by a group of experts to prevent the defects. However, formal and unexpected defects may still occur even after the verification is performed. Further, a turn around time (TAT) to complete the verification may be high when the verification is performed manually by a person. Moreover, it is impossible to respond to all experimental conditions.

In the automated simulation method according to an example embodiment, when at least one of the manufacturing schemes and the manufacturing order is changed in the R&D phase, the verification may be performed automatically using the database, and thus the defects may be prevented more accurately and predictably. For example, the reference data may be derived using the database and by performing the similarity analysis with the existing process, the automated script generation and simulation may be performed based on the reference data, and the risk due to the changes may be predicted as the probability using the deep learning with cumulative data. In addition, the risk due to the changes may be notified at the early stage, and the basis may be provided to decide whether to proceed with the real manufacturing process. Further, when an unexpected defect occurs in the real manufacturing process, the changes and the type of the defect may be updated to the database. Accordingly, the defects may be detected consistently and early by allowing the system to perform human tasks, the risk may be objectively confirmed by the automated simulation using the database and by the deep learning, and the accuracy of the simulation may be maintained by continuously updating the database.

FIGS. 2 and 3 are block diagrams illustrating an automated simulation generation device according to an example embodiment.

Referring to FIG. 2, an automated simulation generation device 1000 includes a processor 1100 and a simulation module 1200. The automated simulation generation device 1000 may perform a simulation using data stored in a database 1700.

Herein, the term “module” may indicate, but is not limited to, a software and/or hardware component, such as a field programmable gate array (FPGA) or an application specific integrated circuit (ASIC), which performs certain tasks. A module may be configured to reside in a tangible addressable storage medium and be configured to execute on one or more processors. For example, a “module” may include components such as software components, object-oriented software components, class components and task components, and processes, functions, routines, segments of program code, drivers, firmware, microcode, circuitry, data, databases, data structures, tables, arrays, and variables. A “module” maybe divided into a plurality of “modules” that perform detailed functions.

The database 1700 may store data used for an operation of the automated simulation generation device 1000. For example, the database 1700 may store recipe related data RCP (e.g., a plurality of recipe sets), script related data SCRT (e.g., a plurality of script sets), deep learning related data DLM (e.g., a plurality of deep learning models), a plurality of data DAT, and rule deck related data RDECK. For example, the plurality of data DAT may include simulation data, real data, and various other data. The real data may also be referred to herein as actual data or measured data from the manufactured semiconductor device. For example, the database 1700 may be located outside the automated simulation generation device 1000. For example, the database 1700 may be located in an external device located external to the automated simulation generation device 1000. However, example embodiments of the inventive concept are not limited thereto. For example, the database 1700 may be included in the automated simulation generation device 1000.

In some example embodiments, the database 1700 may include any non-transitory computer-readable storage medium used to provide commands and/or data to a computer. For example, the non-transitory computer-readable storage medium may include a volatile memory such as a static random access memory (SRAM), a dynamic random access memory (DRAM), or the like, and a nonvolatile memory such as a flash memory, a magnetic random access memory (MRAM), a phase-change random access memory (PRAM), a resistive random access memory (RRAM), or the like. The non-transitory computer-readable storage medium may be inserted into the computer, may be integrated in the computer, or may be coupled to the computer through a communication medium such as a network and/or a wireless link.

The processor 1100 may control an operation of the automated simulation generation device 1000, and may be used when the automated simulation generation device 1000 performs computations or calculations. For example, the processor 1100 may include a micro-processor, an application processor (AP), a central processing unit (CPU), a digital signal processor (DSP), a graphic processing unit (GPU), a neural processing unit (NPU), or the like. Although FIG. 2 illustrates that the automated simulation generation device 1000 includes one processor 1100, example embodiments are not limited thereto. For example, the automated simulation generation device 1000 may include a plurality of processors. In addition, the processor 1100 may include cache memories to increase computation capacity.

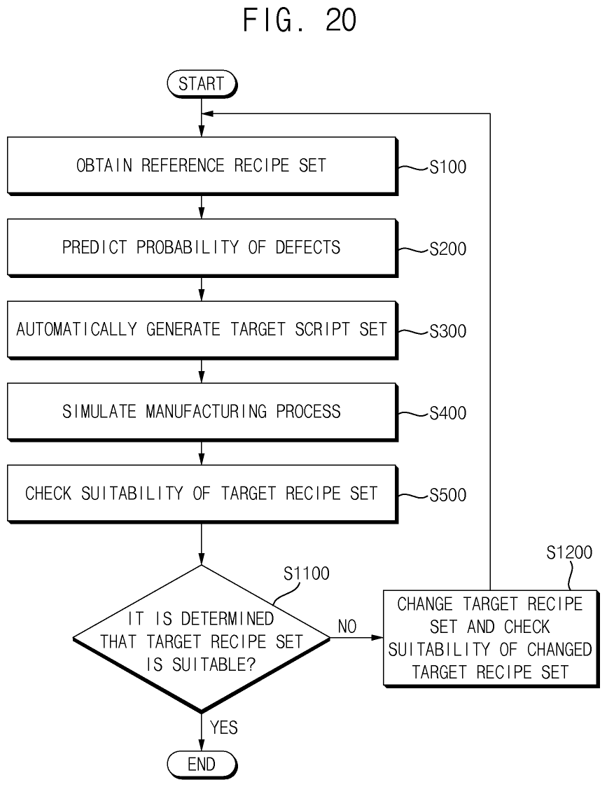

The simulation module 1200 may perform the automated simulation method according to an example embodiment described with reference to FIG. 1, and may perform an automated simulation method according to an example embodiment which will be described with reference to FIG. 20. The simulation module 1200 may include a similarity analysis module 1300, a deep learning module 1400, an automated script generation module 1500 and an automated simulation module 1600.

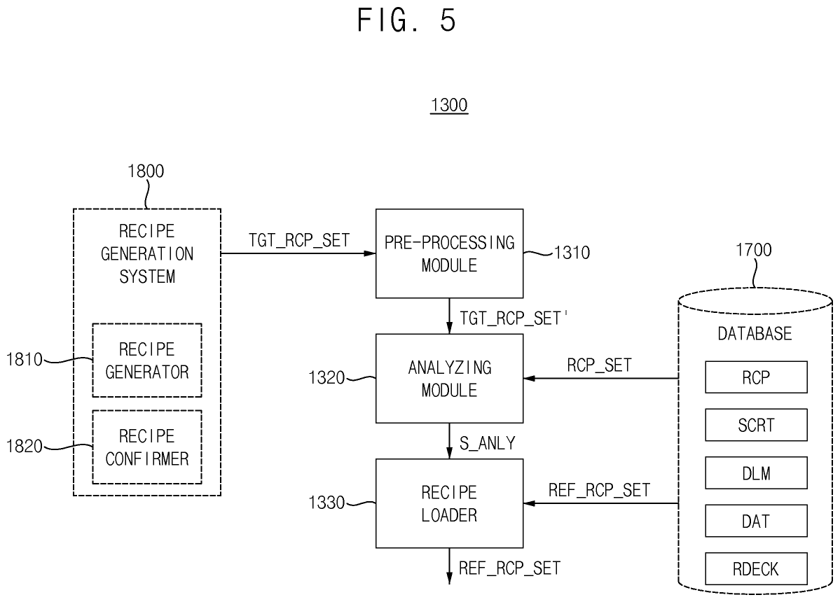

The similarity analysis module 1300 may obtain a reference recipe set REF_RCP_SET by searching the database 1700 based on a target recipe set TGT_RCP_SET in which a manufacturing scheme and a manufacturing order of a semiconductor device are defined (e.g., the target recipe set TGT_RCP_SET associated with a manufacturing process of the semiconductor device). The reference recipe set REF_RCP_SET may have the highest similarity to the target recipe set TGT_RCP_SET. In other words, the similarity analysis module 1300 may perform operation S100 in FIG. 1. A configuration of the similarity analysis module 1300 will be described with reference to FIG. 5.

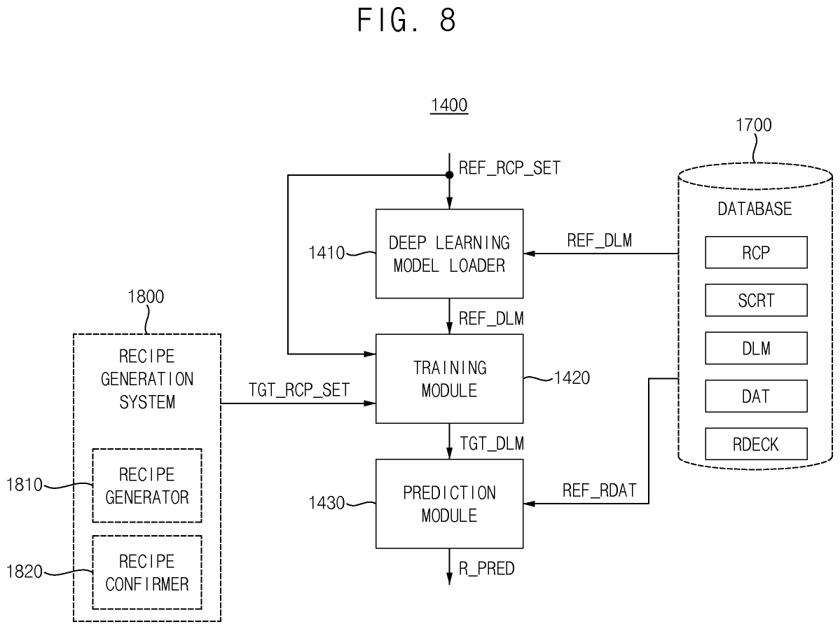

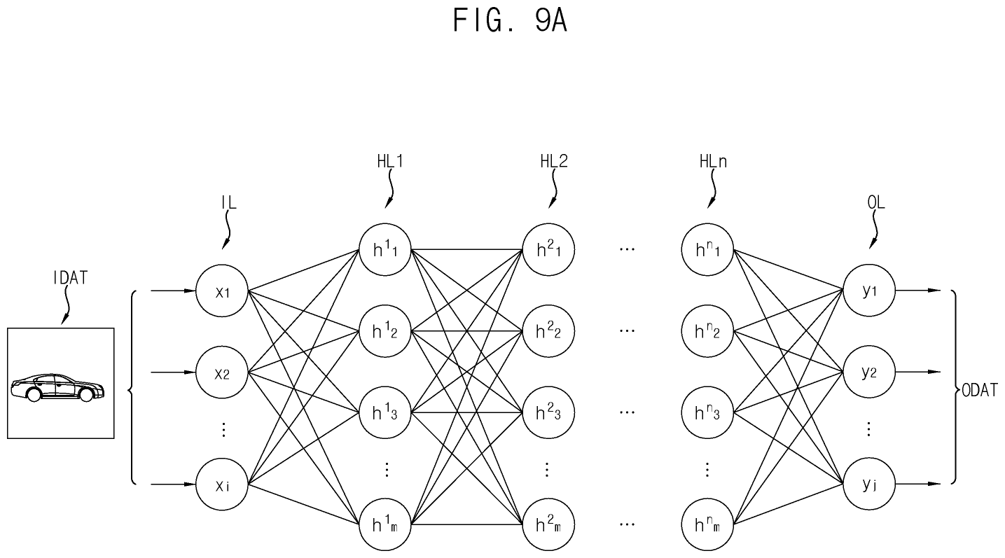

The deep learning module 1400 may predict a probability of one or more defects in the manufacturing process of the semiconductor device when the target recipe set TGT_RCP_SET is to be applied to the manufacturing process, and may output a prediction result signal R_PRED representing or indicating a result of predicting the probability of the defects. For example, prediction result signal R_PRED may indicate the probability of each of the defects. The deep learning module 1400 may predict the probability of the defects by performing a deep learning based on the database 1700, the target recipe set TGT_RCP_SET and the reference recipe set REF_RCP_SET. In other words, the deep learning module 1400 may perform operation S200 in FIG. 1. A configuration of the deep learning module 1400 will be described with reference to FIG. 8.

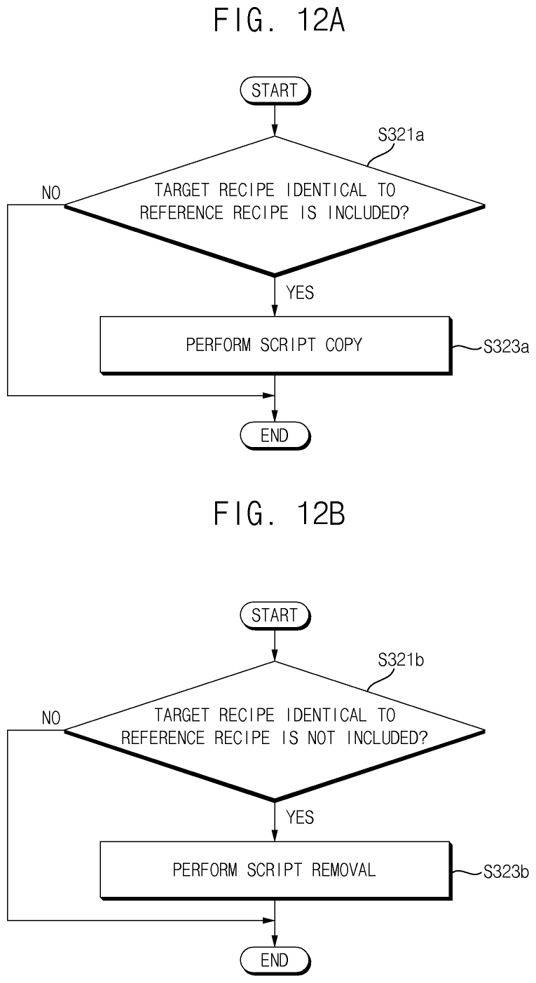

The automated script generation module 1500 may automatically generate a target script set TGT_SCRT_SET corresponding to the target recipe set TGT_RCP_SET by comparing the target recipe set TGT_RCP_SET with the reference recipe set REF_RCP_SET. In other words, the automated script generation module 1500 may perform operation S300 in FIG. 1. A configuration of the automated script generation module 1500 will be described with reference to FIG. 11.

The automated simulation module 1600 may simulate the manufacturing process of the semiconductor device when the target recipe set TGT_RCP_SET is to be applied to the manufacturing process based on the target script set TGT_SCRT_SET, may check a suitability of the target recipe set TGT_RCP_SET based on the result of predicting the probability of the defects and a result of simulating the manufacturing process, and may output a determination signal DET representing a result of checking the suitability of the target recipe set TGT_RCP_SET. For example, the automated simulation module 1600 may simulate the manufacturing process of the semiconductor device using the target script set TGT_SCRT_SET. For example, the determination signal DET may indicate whether or not the target recipe set TGT_RCP_SET is capable of manufacturing the semiconductor device without defects or with a lower amount of defects. In other words, the automated simulation module 1600 may perform operations S400 and S500 in FIG. 1. A configuration of the automated simulation module 1600 will be described with reference to FIG. 19.

In some example embodiments, the similarity analysis module 1300, the deep learning module 1400, the automated script generation module 1500 and the automated simulation module 1600 may be implemented as instructions or program code that may be executed by the processor 1100. For example, the instructions or program code of the similarity analysis module 1300, the deep learning module 1400, the automated script generation module 1500 and the automated simulation module 1600 may be stored in a computer readable medium. For example, the processor 1100 may load the instructions or program code to a working memory (e.g., a DRAM, etc.).

In other example embodiments, the processor 1100 may be manufactured to efficiently execute instructions or program code included in the similarity analysis module 1300, the deep learning module 1400, the automated script generation module 1500 and the automated simulation module 1600. For example, the processor 1100 may efficiently execute the instructions or program code from various AI modules and/or machine learning modules. For example, the processor 1100 may receive information corresponding to the similarity analysis module 1300, the deep learning module 1400, the automated script generation module 1500 and the automated simulation module 1600 to operate the similarity analysis module 1300, the deep learning module 1400, the automated script generation module 1500 and the automated simulation module 1600.

In some example embodiments, the similarity analysis module 1300, the deep learning module 1400, the automated script generation module 1500 and the automated simulation module 1600 may be implemented as a single integrated module. In other example embodiments, the similarity analysis module 1300, the deep learning module 1400, the automated script generation module 1500 and the automated simulation module 1600 may be implemented as separate and different modules.

Referring to FIG. 3, an automated simulation generation device 2000 for a semiconductor device includes a processor 2100, an input/output (I/O) device 2200, a network interface 2300 (e.g., a network card, a network interface circuit, etc.), a random access memory (RAM) 2400, a read only memory (ROM) 2500 and/or a storage device 2600. FIG. 3 illustrates an example where all of the similarity analysis module 1300, the deep learning module 1400, the automated script generation module 1500 and the automated simulation module 1600 in FIG. 2 are implemented in software.

The automated simulation generation device 2000 may be a computing system. For example, the computing system may be a fixed computing system such as a desktop computer, a workstation or a server, or may be a portable computing system such as a laptop computer.

The processor 2100 may be substantially the same as the processor 1100 in FIG. 2. For example, the processor 2100 may include a core or a processor core for executing an arbitrary instruction set (for example, intel architecture-32 (IA-32), 64 bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the similarity analysis module 1300, the deep learning module 1400, the automated script generation module 1500 and the automated simulation module 1600 in FIG. 2 or at least some elements of the program PR, and the program PR may allow the processor 2100 to perform operations for the simulation in the semiconductor design phase (e.g., operations S100, S200, S300, S400 and S500 in FIG. 1).

In other words, the program PR may include a plurality of instructions and/or procedures executable by the processor 2100, and the plurality of instructions and/or procedures included in the program PR may allow the processor 2100 to perform the operations for the simulation in the semiconductor design phase according to example embodiments. Each of the procedures may denote a series of instructions for performing a certain task. A procedure may be referred to as a function, a routine, a subroutine, or a subprogram. Each of the procedures may process data provided from the outside and/or data generated by another procedure.

In some example embodiments, the RAM 2400 may include any volatile memory such as an SRAM, a DRAM, or the like.

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

The storage device 2600 may store data, which is to be processed by the processor 2100, or data obtained through processing by the processor 2100. The processor 2100 may process the data stored in the storage device 2600 to generate new data, based on the program PR and may store the generated data in the storage device 2600.

The I/O device 2200 may include an input device, such as a keyboard, a pointing device,

or the like, and may include an output device such as a display device, a printer, or the like. For example, a user may trigger, through the I/O devices 2200, execution of the program PR by the processor 2100, and may provide or check various inputs, outputs and/or data, etc.

The network interface 2300 may provide access to a network outside the automated simulation generation device 2000. For example, the network may include a plurality of computing systems and communication links, and the communication links may include wired links, optical links, wireless links, or arbitrary other type links. Various inputs may be provided to the automated simulation generation device 2000 through the network interface 2300, and various outputs may be provided to another computing system through the network interface 2300.

In some example embodiments, the computer program code, the similarity analysis module 1300, the deep learning module 1400, the automated script generation module 1500 and/or the automated simulation module 1600 may be stored in a transitory or non-transitory computer readable medium. In some example embodiments, values resulting from the simulation performed by the processor 2100 or values obtained from arithmetic processing performed by the processor 2100 may be stored in a transitory or non-transitory computer readable medium. In some example embodiments, intermediate values during the simulation and/or various data generated by the simulation may be stored in a transitory or non-transitory computer readable medium. However, example embodiments are not limited thereto.

FIG. 4 is a flowchart illustrating an example of obtaining a reference recipe set in FIG. 1.

Referring to FIGS. 1 and 4, in operation S100, a pre-processing may be performed on the target recipe set (operation S110), a similarity analysis may be performed on the target recipe set with a plurality of recipe sets stored in the database (operation S120), and the reference recipe set among the plurality of recipe sets may be loaded from the database based on a result of performing the similarity analysis (operation S130). The pre-processing step may be omitted. When the pre-processing is performed, the pre-processing converts a first target recipe set into a second target receipe set having a format different from the first target receipt set, the similarity analysis is performed on the second target receipe set and the plurality of recipe sets have the same format.

FIG. 5 is a block diagram illustrating an example of a similarity analysis module included in an automated simulation generation device of FIG. 2.

Referring to FIG. 5, the similarity analysis module 1300 may include a pre-processing module 1310, an analyzing module 1320 and a recipe loader 1330.

The pre-processing module 1310 may perform a pre-processing on the target recipe set TGT_RCP_SET, and may output the pre-processed target recipe set TGT_RCP_SET′. In other words, the pre-processing module 1310 may perform operation S110 in FIG. 4. For example, process information (e.g., process steps, unit processes, etc.) and order information (e.g., processing order) associated with or for the target recipe set TGT_RCP_SET may be extracted by the pre-processing. For example, the pre-processed target recipe set TGT_RCP_SET′ may indicate manufacturing steps and an order of these steps.

In an example embodiment, the target recipe set TGT_RCP_SET is received from a recipe generation system 1800 located outside the similarity analysis module 1300 (e.g., located outside the automated simulation generation device 1000 in FIG. 2). For example, the recipe generation system 1800 may include a recipe generator 1810 and a recipe confirmer 1820, and the target recipe set TGT_RCP_SET, which is a new (or changed) recipe set not previously applied, may be generated by the recipe generator 1810.

The analyzing module 1320 may perform a similarity analysis based on the pre-processed target recipe set TGT_RCP_SET′. For example, the analyzing module 1320 may receive a plurality of recipe sets RCP_SET stored in the database 1700, and may perform the similarity analysis on the target recipe set TGT_RCP_SET with the plurality of recipe sets RCP_SET. For example, the analyzing module 1320 may perform the similarity analysis on the pre-processed target recipe set TGT_RCP_SET′ with the plurality of recipe sets RCP_SET. In other words, the analyzing module 1320 may perform operation S120 in FIG. 4.

The recipe loader 1330 may load the reference recipe set REF_RCP_SET among the plurality of recipe sets RCP_SET from the database 1700 based on a result of performing the similarity analysis. In other words, the recipe loader 1330 may perform operation S130 in FIG. 4.

In an example embodiment, the plurality of recipe sets RCP_SET and the reference recipe set REF_RCP_SET that are stored in the database 1700 are recipe sets that have already been applied to the manufacturing process of the semiconductor device. For example, the plurality of recipe sets RCP_SET may have been previously used to manufacture the semiconductor device.

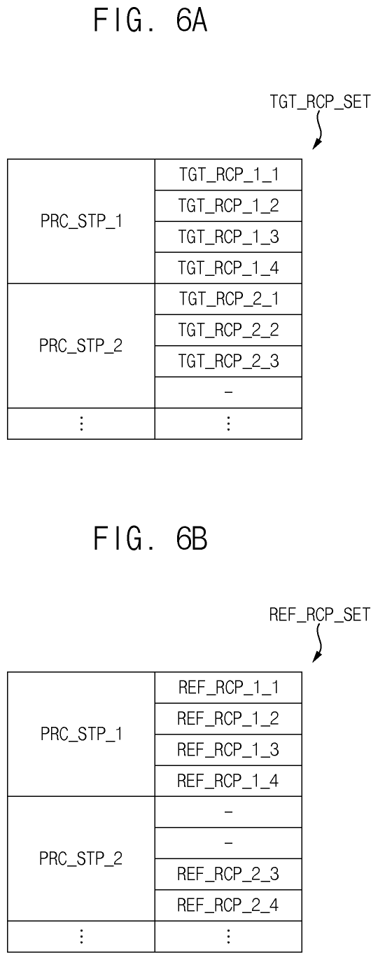

FIGS. 6A and 6B are diagrams illustrating examples of a target recipe set and a reference recipe set that are obtained by operations of FIGS. 4 and 5.

Referring to FIGS. 6A and 6B, the target recipe set TGT_RCP_SET may include a plurality of target recipes TGT_RCP_1_1, TGT_RCP_1_2, TGT_RCP_1_3, TGT_RCP_1_4, TGT_RCP_2_1, TGT_RCP_2_2 and TGT_RCP_2_3, and the reference recipe set REF_RCP_SET may include a plurality of reference recipes REF_RCP_1_1, REF_RCP_1_2, REF_RCP_1_3, REF_RCP_1_4, REF_RCP_2_3 and REF_RCP_2_4. For example, the target recipes TGT_RCP_1_1 to TGT_RCP_1_4 and the reference recipes REF_RCP_1_1 to REF_RCP_1_4 may be included in a first process step PRC_STP_1, and the target recipes TGT_RCP_2_1 to TGT_RCP_2_3 and the reference recipes REF_RCP_2_3 and REF_RCP_2_4 may be included in a second process step PRC_STP_2. For example, the second process step PRC_STP_2 may be performed sequentially after the first process step PRC_STP_1.

In some example embodiments, each of the target recipes TGT_RCP_1_1 to TGT_RCP_1_4 and TGT_RCP_2_1 to TGT_RCP_2_3 and each of the reference recipes REF_RCP_1_1 to REF_RCP_1_4, REF_RCP_2_3 and REF_RCP_2_4 may include unit process information such as deposition, photo lithography, etching, and/or the like, and process description information such as material, time, rate, and/or the like. As described above, the manufacturing schemes and order may be represented by a combination of the recipes.

FIG. 7 is a flowchart illustrating an example of predicting a probability of defects in FIG. 1 according to an example embodiment.

Referring to FIGS. 1 and 7, in operation S200, a reference deep learning model corresponding to the reference recipe set among a plurality of deep learning models is loaded from the database (operation S210), a target deep learning model corresponding to the target recipe set is generated based on the target recipe set, the reference recipe set and the reference deep learning model (operation S220), and the probability of the defects are calculated based on the target deep learning model and a result of performing the manufacturing process of the semiconductor device by applying the reference recipe set (operation S230).

FIG. 8 is a block diagram illustrating an example of a deep learning module included in an automated simulation generation device of FIG. 2 according to an example embodiment.

Referring to FIG. 8, the deep learning module 1400 may include a deep learning model loader 1410, a training module 1420 and a prediction module 1430.

The deep learning model loader 1410 may load a reference deep learning model REF_DLM corresponding to the reference recipe set REF_RCP_SET among a plurality of deep learning models (e.g., among the deep learning related data DLM) from the database 1700. In other words, the deep learning model loader 1410 may perform operation S210 in FIG. 7. For example, the reference deep learning model REF_DLM may be a deep learning model that has already been trained based on the reference recipe set REF_RCP_SET, which has already been applied to the manufacturing process of the semiconductor device. For example, the semiconductor device may have been previouously manufactured using the reference recipe set REF_RCP_SET.

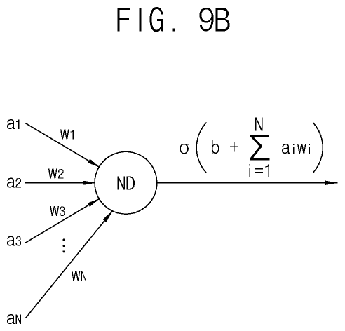

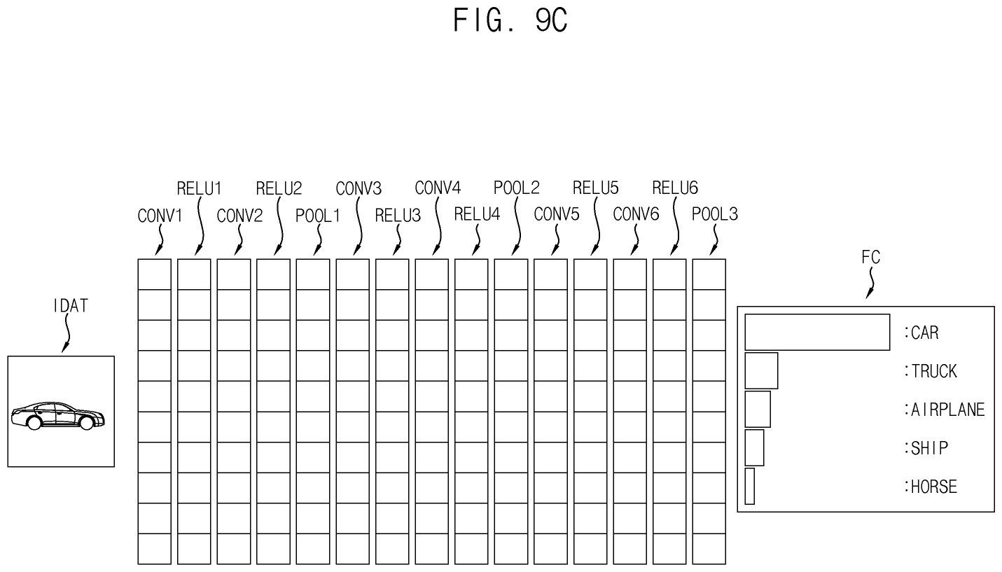

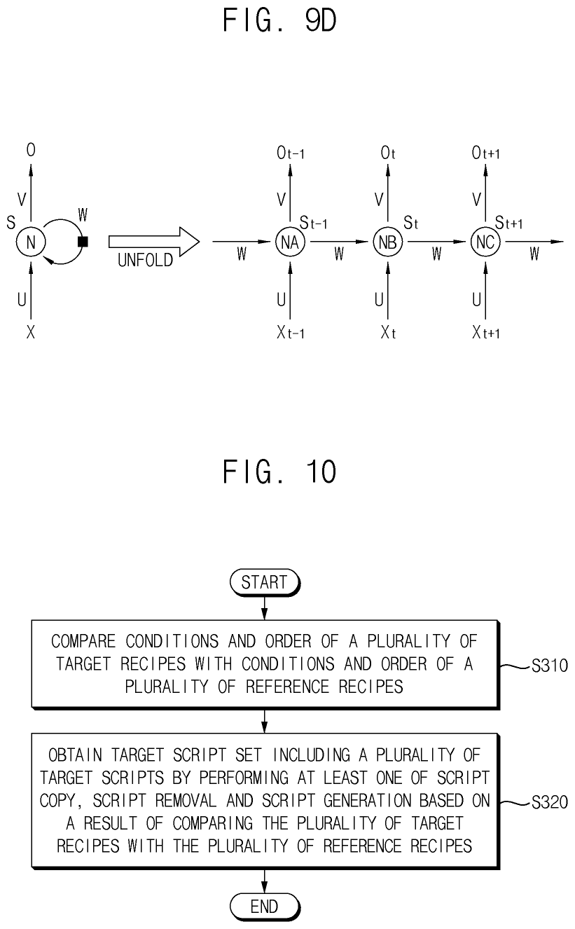

The training module 1420 may generate a target deep learning model TGT_DLM corresponding to the target recipe set TGT_RCP_SET based on the target recipe set TGT_RCP_SET, the reference recipe set REF_RCP_SET and the reference deep learning model REF_DLM. In other words, the training module 1420 may perform operation S220 in FIG. 7. Example structures related to the deep learning model will be described with reference to FIGS. 9A, 9B, 9C and 9D.

In some example embodiments, as described with reference to FIGS. 6A and 6B, the target recipe set TGT_RCP_SET may include a plurality of target recipes, and the reference recipe set REF_RCP_SET may include a plurality of reference recipes. The target deep learning model TGT_DLM may be generated by comparing conditions and an order of the plurality of target recipes with conditions and an order of the plurality of reference recipes, by identifying a difference (e.g., changed parts) between the target recipe set and the reference recipe set based on a result of comparing the plurality of target recipes with the plurality of reference recipes, and by performing a transfer learning or re-learning on the reference deep learning model REF_DLM. For example, as the transfer learning or re-learning is performed, a plurality of weights included in the deep learning model may be updated.

The prediction module 1430 may calculate the probability of the defects based on the target deep learning model TGT_DLM and reference real data REF_RDAT, which corresponds to a result of performing the manufacturing process of the semiconductor device by applying the reference recipe set REF_RCP_SET, and may output the prediction result signal R_PRED representing the result of predicting the probability of the defects. In other words, the prediction module 1430 may perform operation S230 in FIG. 7. The reference real data REF_RDAT may be characteristics or parameters of the semiconductor device that was manufactured using the reference recipe set REF_RCP_SET.

FIGS. 9A, 9B, 9C and 9D are diagrams illustrating examples of a neural network associated with a deep learning model that is trained and generated by a deep learning module of FIG. 8.

Referring to FIG. 9A, a general neural network (or artificial neural network) may include an input layer IL, a plurality of hidden layers HL1, HL2, . . . , HLn and an output layer OL.

The input layer IL may include i input nodes x₁, x₂, . . . , xᵢ, where i is a natural number. Input data (e.g., vector input data) IDAT whose length is i may be input to the input nodes x₁ to xᵢ such that each element of the input data IDAT is input to a respective one of the input nodes x₁ to xᵢ. The input data IDAT may include information associated with the various features of the different classes to be categorized.

The plurality of hidden layers HL1, HL2, . . . , HLn may include n hidden layers, where n is a natural number, and may include a plurality of hidden nodes h¹₁, h¹₂, h¹₃, . . . , h¹ₘ, h²₁, h²₂, h²₃, . . . , h²ₘ, hⁿ₁, hⁿ₂, hⁿ₃, . . . , hⁿₘ. For example, the hidden layer HL1 may include m hidden nodes h¹₁ to h¹ₘ, the hidden layer HL2 may include m hidden nodes h²₁ to h²ₘ, and the hidden layer HLn may include m hidden nodes hⁿ₁ to hⁿₘ, where m is a natural number.

The output layer OL may include j output nodes y₁, y₂, . . . , yⱼ, where j is a natural number. Each of the output nodes y₁ to yⱼ may correspond to a respective one of classes to be categorized. The output layer OL may generate output values (e.g., class scores or numerical output such as a regression variable) and/or output data ODAT associated with the input data IDAT for each of the classes. In some example embodiments, the output layer OL may be a fully-connected layer and may indicate, for example, a probability that the input data IDAT corresponds to a car.

A structure of the neural network illustrated in FIG. 9A may be represented by information on branches (or connections) between nodes illustrated as lines, and a weighted value assigned to each branch, which is not illustrated. In some neural network models, nodes within one layer may not be connected to one another, but nodes of different layers may be fully or partially connected to one another. In some other neural network models, such as unrestricted Boltzmann machines, at least some nodes within one layer may also be connected to other nodes within one layer in addition to (or alternatively with) one or more nodes of other layers.

Each node (e.g., the node h¹₁) may receive an output of a previous node (e.g., the node x₁), may perform a computing operation, computation or calculation on the received output, and may output a result of the computing operation, computation or calculation as an output to a next node (e.g., the node h²₁). Each node may calculate a value to be output by applying the input to a specific function, e.g., a nonlinear function. This function may be referred to as the activation function for the node.

In some example embodiments, the structure of the neural network is set in advance, and the weighted values for the connections between the nodes are set appropriately by using sample data having a sample answer (also referred to as a “label”), which indicates a class the data corresponding to a sample input value. The data with the sample answer may be referred to as “training data”, and a process of determining the weighted values may be referred to as “training”. The neural network may “learn” to associate the data with corresponding labels during the training process. A group of an independently trainable neural network structure and the weighted values that have been trained using an algorithm may be referred to as a “model”, and a process of predicting, by the model with the determined weighted values, which class new input data belongs to, and then outputting the predicted value, may be referred to as a testing process or operating the neural network in inference mode.

Referring to FIG. 9B, an example of an operation (e.g., computation or calculation) performed by one node ND included in the neural network of FIG. 9A is illustrated in detail.

Based on N inputs a₁, a₂, a₃, . . . , a_{N} provided to the node ND, where N is a natural number greater than or equal to two, the node ND may multiply the N inputs a₁ to a_{N} and corresponding N weights w₁, w₂, w₃, . . . , w_{N}, respectively, may sum N values obtained by the multiplication, may add an offset “b” to “a”summed value, and may generate one output value (e.g., “z”) by applying a value to which the offset “b” is “a”ded to a specific function “σ”.

In some example embodiments and as illustrated in FIG. 9B, one layer included in the neural network illustrated in FIG. 9A may include M nodes ND, where M is a natural number greater than or equal to two, and output values of the one layer may be obtained by Equation 1.

W*A=Z [Equation 1]

In Equation 1, “W” denotes a weight set including weights for all connections included in the one layer, and may be implemented in an M*N matrix form. “A” denotes an input set including the N inputs a₁ to a_{N} received by the one layer, and may be implemented in an N*1 matrix form. “Z” denotes an output set including M outputs z₁, z₂, z₃, . . . , z_{M} output from the one layer, and may be implemented in an M*1 matrix form.

The general neural network illustrated in FIG. 9A may not be suitable for handling input image data (or input sound data) because each node (e.g., the node h¹₁) is connected to all nodes of a previous layer (e.g., the nodes x₁, x₂, . . . , xᵢ included in the layer IL) and then the number of weighted values drastically increases as the size of the input image data increases. Thus, a convolutional neural network (CNN), which is implemented by combining the filtering technique with the general neural network may be used such that a two-dimensional image, as an example of the input image data, is efficiently trained by the convolutional neural network.

Referring to FIG. 9C, a convolutional neural network may include a plurality of layers CONV1, RELU1, CONV2, RELU2, POOL1, CONV3, RELU3, CONV4, RELU4, POOL2, CONV5, RELU5, CONV6, RELU6, POOL3 and FC. Here, “CONV” denotes a convolutional layer, “RELU” denotes a rectified linear unit activation function, “POOL” denotes a pooling layer, and “FC” denotes a fully-connected layer.

Unlike the general neural network, each layer of the convolutional neural network may have three dimensions of a width, a height and a depth, and thus data that is input to each layer may be volume data having three dimensions of a width, a height and a depth. For example, if an input image in FIG. 9C has a size having a width of 32 units (e.g., 32 pixels) and a height of 32 units and three color channels R, G and B, input data IDAT corresponding to the input image may have a size of 32*32*3. The input data IDAT in FIG. 9C may be referred to as input volume data or input activation volume.

Each of the convolutional layers CONV1 to CONV6 may perform a convolutional operation on input volume data. In an image processing operation, the convolutional operation represents an operation in which image data is processed based on a mask with weighted values and an output value is obtained by multiplying input values by the weighted values and adding up the total multiplication results. The mask may be referred to as a filter, a window, or a kernel.

Parameters of each convolutional layer may include a set of learnable filters. Every filter may be small spatially (along a width and a height), but may extend through the full depth of an input volume. For example, during the forward pass, each filter may be slid (e.g., convolved) across the width and height of the input volume, and dot products may be computed between the entries of the filter and the input at any position. As the filter is slid over the width and height of the input volume, a two-dimensional activation map corresponding to responses of that filter at every spatial position may be generated. As a result, an output volume may be generated by stacking these activation maps along the depth dimension. For example, if input volume data having a size of 32*32*3 passes through the convolutional layer CONV1 having four filters with zero-padding, output volume data of the convolutional layer CONV1 may have a size of 32*32*12 (e.g., a depth of volume data increases).

Each of the RELU layers RELU1 to RELU6 may perform a rectified linear unit (RELU) operation that corresponds to an activation function defined by, e.g., a function f(x)=max(0, x) (e.g., an output is zero for all negative input x). For example, if input volume data having a size of 32*32*12 passes through the RELU layer RELU1 to perform the rectified linear unit operation, output volume data of the RELU layer RELU1 may have a size of 32*32*12 (e.g., a size of volume data is maintained).

Each of the pooling layers POOL1 to POOL3 may perform a down-sampling operation on input volume data along spatial dimensions of width and height. For example, four input values arranged in a 2*2 matrix formation may be converted into one output value based on a 2*2 filter. For example, a maximum value of four input values arranged in a 2*2 matrix formation may be selected based on 2*2 maximum pooling, or an average value of four input values arranged in a 2*2 matrix formation may be obtained based on 2*2 average pooling. For example, if input volume data having a size of 32*32*12 passes through the pooling layer POOL1 having a 2*2 filter, output volume data of the pooling layer POOL1 may have a size of 16*16*12 (e.g., a width and a height of volume data decreases, and a depth of volume data is maintained).

Typically, convolutional layers may be repeatedly arranged in the convolutional neural network, and the pooling layer may be periodically inserted in the convolutional neural network, thereby reducing a spatial size of an image and extracting a characteristic of the image.

The output layer or fully-connected layer FC may output results (e.g., class scores) of the input volume data IDAT for each of the classes. For example, the input volume data IDAT corresponding to the two-dimensional image may be converted into a one-dimensional matrix or vector, which may be referred to as an embedding, as the convolutional operation and the down-sampling operation are repeated. For example, the fully-connected layer FC may indicate probabilities that the input volume data IDAT corresponds to a car, a truck, an airplane, a ship and a horse.

The types and number of layers included in the convolutional neural network are not limited to an example described with reference to FIG. 9C and may be variously determined according to example embodiments. In addition, the convolutional neural network may further include other layers such as a softmax layer for converting score values corresponding to predicted results into probability values, a bias adding layer for adding at least one bias, or the like. The bias may also be incorporated into the activation function.

Referring to FIG. 9D, a recurrent neural network (RNN) may include a repeating structure using a specific node and/or cell N illustrated on the left side of FIG. 9D.

A structure illustrated on the right side of FIG. 9D may represent that a recurrent connection of the RNN illustrated on the left side is unfolded (and/or unrolled). The term “unfolded” (or unrolled) means that the network is written out or illustrated for the complete or entire sequence including all nodes NA, NB, and NC. For example, if the sequence of interest is a sentence of 3 words, the RNN may be unfolded into a 3-layer neural network, one layer for each word (e.g., without recurrent connections or without cycles).

In the RNN in FIG. 9D, “X” represents an input of the RNN. For example, Xₜ may be an input at time step t, and Xₜ₋₁ and Xₜ₊₁ may be inputs at time steps t−1 and t+1, respectively.

In the RNN in FIG. 9D, “S” represents a hidden state. For example, Sₜ may be a hidden state at the time step t, and Sₜ₋₁ and Sₜ₊₁ may be hidden states at the time steps t−1 and t+1, respectively. The hidden state may be calculated based on a previous hidden state and an input at a current step. For example, Sₜ=f(UXₜ+WSₜ₋₁ ). For example, the function f may be usually a nonlinearity function such as tanh or RELU. S₋₁, which may be used to calculate a first hidden state, may be typically initialized to all zeroes.

In the RNN in FIG. 9D, “O” represents an output of the RNN. For example, Oₜ may be an output at the time step t, and Oₜ₋₁ and Oₜ₊₁ may be outputs at the time steps t−1 and t+1, respectively. For example, if the RNN is configured to predict a next word in a sentence, Oₜ would represent a vector of probabilities across a vocabulary. For example, Oₜ=softmax(VSₜ).

In the RNN in FIG. 9D, the hidden state “S” maybe a “memory” (or history) of the network. For example, the “memory” of the RNN may have captured information about and/or be based on what has been calculated so far. In some example embodiments, the hidden state S does not include a record of what has been calculated, but may, for example, be a result of some and/or all the calculations in the previous steps. The hidden state Sₜ may capture information about what happened in all the previous time steps. The training of the RNN may, therefore, be based on the “memory” of the network. The output Oₜ may be calculated solely based on the training at the current time step t. In addition, unlike a traditional neural network, which uses different parameters at each layer, the RNN may share the same parameters (e.g., U, V, and W in FIG. 9D) across all time steps. This may represent the fact that the same task may be performed at each step, just with different inputs. This may greatly reduce the total number of parameters required to be trained or learned.

Although examples of the neural network associated with the deep learning model are described, the inventive concept is not limited thereto. The deep learning model may be implemented using various other neural networks such as generative adversarial network (GAN), region with convolutional neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzman machine (RBM), fully convolutional network, long short-term memory (LSTM) Network. Alternatively or additionally, the neural network may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests.

FIG. 10 is a flowchart illustrating an example of automatically generating a target script set in FIG. 1.

Referring to FIGS. 1 and 10, in operation S300, conditions and an order of a plurality of target recipes included in the target recipe set are compared with conditions and an order of a plurality of reference recipes included in the reference recipe set (operation S310), and the target script set including a plurality of target scripts corresponding to the plurality of target recipes is obtained by performing at least one of a script copy, a script removal and a script generation based on a result of comparing the plurality of target recipes with the plurality of reference recipes (operation S320). For example, conditions of the plurality of target recipes included in the target recipe set may be compared with the conditions of the plurality of reference recipes included in the reference recipe set, and the order of manufacturing steps of the plurality of target recipes may be compared with the order of manufacturing steps of the plurality of reference recipes.

FIG. 11 is a block diagram illustrating an example of an automated script generation module included in an automated simulation generation device of FIG. 2.

Referring to FIG. 11, the automated script generation module 1500 may include a comparison module 1510, a script copy module 1520, a script removal module 1530, a script generation module 1540 and a target script generation module 1550.

The comparison module 1510 may compare conditions and an order of the plurality of target recipes included in the target recipe set TGT_RCP_SET with conditions and an order of the plurality of reference recipes included in the reference recipe set REF_RCP_SET, and may generate a comparison result signal COMP representing a result of comparing the target recipe set TGT_RCP_SET with the reference recipe set REF_RCP_SET. In other words, the comparison module 1510 may perform operation S310 in FIG. 10.

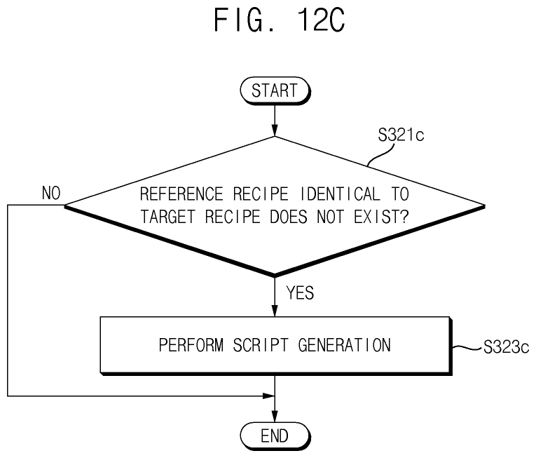

The script copy module 1520 may perform a script copy based on the result of comparing the target recipe set TGT_RCP_SET with the reference recipe set REF_RCP_SET, and may generate a signal SCRT_CPY representing a result of the script copy. The script removal module 1530 may perform a script removal based on the result of comparing the target recipe set TGT_RCP_SET with the reference recipe set REF_RCP_SET, and may generate a signal SCRT_RMV representing a result of the script removal. The script generation module 1540 may perform a script generation based on the result of comparing the target recipe set TGT_RCP_SET with the reference recipe set REF_RCP_SET, and may generate a signal SCRT_GEN representing a result of the script generation. For example, the rule deck related data RDECK stored in the database 1700 may be used to perform the script generation. The script copy, the script removal and the script generation will be described with reference to FIGS. 12A, 12B, 12C, 13, 14, 15, 16 and 17.

The target script generation module 1550 may generate the target script set TGT_SCRT_SET including a plurality of target scripts corresponding to the plurality of target recipes based on the results of the script copy, the script removal and the script generation, and may output the target script set TGT_SCRT_SET. For example, the target script set TGT_SCRT_SET may be stored in the database 1700.

Operation S320 in FIG. 10 may be performed by the script copy module 1520, the script removal module 1530, the script generation module 1540 and the target script generation module 1550.

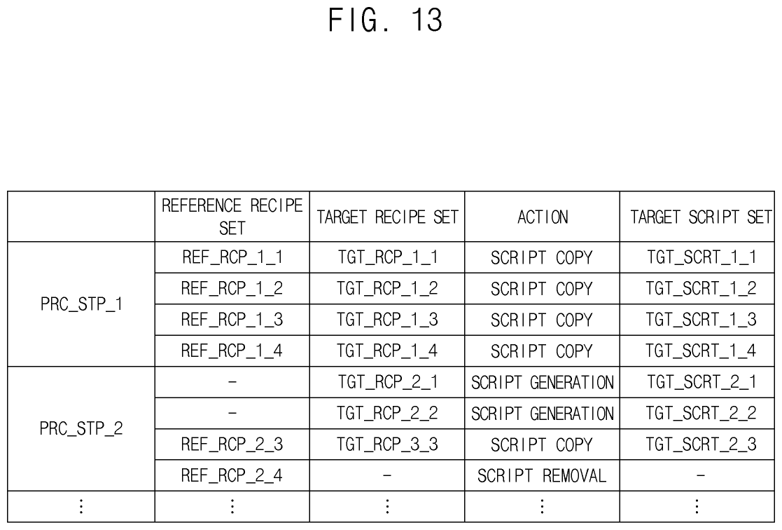

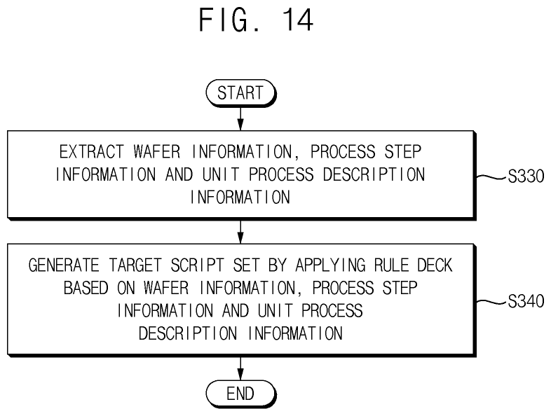

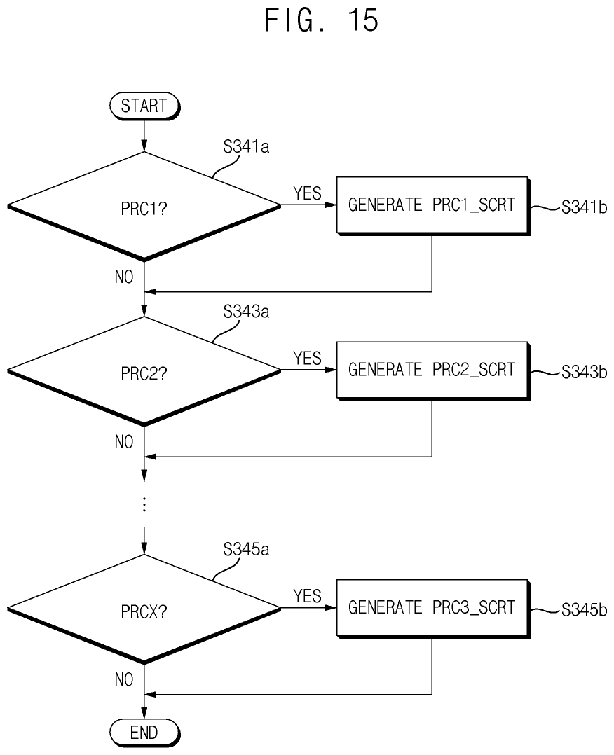

FIGS. 12A, 12B and 12C are flowcharts illustrating examples of obtaining a target script set in FIG. 10. FIG. 13 is a diagram for describing operations of FIGS. 12A, 12B and 12C.

Referring to FIGS. 10, 12A and 13, in operation S320, when a first target recipe identical to or equal to a first reference recipe among the plurality of reference recipes is included in the plurality of target recipes (operation S321a: YES), the script copy is performed such that a first target script corresponding to the first target recipe is provided to the target script set (operation S323a).

For example, as illustrated in FIG. 13, the target recipes TGT_RCP_1_1 to TGT_RCP_1_4 and TGT_RCP_2_3 that are identical to the reference recipes REF_RCP_1_1 to REF_RCP_1_4 and REF_RCP_2_3 may exist in the target recipe set TGT_RCP_SET, and thus the script copy may be performed for the reference recipes REF_RCP_1_1 to REF_RCP_1_4 and REF_RCP_2_3 and the target recipes TGT_RCP_1_1 to TGT_RCP_1_4 and TGT_RCP_2_2. As a result, target scripts TGT_SCRT_1_1, TGT_SCRT_1_2, TGT_SCRT_1_3, TGT_SCRT_1_4 and TGT_SCRT_2_3, which correspond to the reference recipes REF_RCP_1_1 to REF_RCP_1_4 and REF_RCP_2_3 and correspond to the target recipes TGT_RCP_1_1 to TGT_RCP_1_4 and TGT_RCP_2_3, may be included in the target script set TGT_SCRT_SET. In FIG. 13, recipes (e.g., “REF_RCP_1_1” and “TGT_RCP_1_1”) written with the same numbers (e.g., “1_1”) at the end may represent the same recipes.

Referring to FIGS. 10, 12B and 13, in operation S320, when a second target recipe identical to a second reference recipe among the plurality of reference recipes is not included in the plurality of target recipes (operation S321b: YES), the script removal may be performed such that a second target script corresponding to the second target recipe is not provided to the target script set (operation S323b).

For example, as illustrated in FIG. 13, a target recipe that is identical to the reference recipe REF_RCP_2_4 is not presented in the target recipe set TGT_RCP_SET. For example, the script removal was performed for the reference recipe REF_RCP_2_4. As a result, a target script corresponding to the reference recipe REF_RCP_2_4 is not included in the target script set TGT_SCRT_SET.

Referring to FIGS. 10, 12C and 13, in operation S320, when a third reference recipe identical to a third target recipe among the plurality of target recipes is not included in the plurality of reference recipes (operation S321c: YES), the script generation is performed such that provide a third target script corresponding to the third target recipe is provided to the target script set (operation S323c).

For example, as illustrated in FIG. 13, reference recipes that are identical to the target recipes TGT_RCP_2_1 and TGT_RCP_2_2 are not present in the reference recipe set REF_RCP_SET, and thus the script generation may be performed for the target recipes TGT_RCP_2_1 and TGT_RCP_2_2. As a result, target scripts TGT_SCRT_2_1 and TGT_SCRT_2_2 corresponding to the target recipes TGT_RCP_2_1 and TGT_RCP_2_2 may be included in the target script set TGT_SCRT_SET.

For example, when the reference recipe set REF_RCP_SET has no recipe at a same process step in which the target recipe set TGT_RCP_SET has a first recipe, the target script set TGT_SCRT_SET includes the first recipe. For example, when the reference recipe set REF_RCP_SET has a second recipe at a same process step in which the target recipe set TGT_RCP_SET has a third recipe, the target script set TGT_SCRT_SET includes the second receipe. For example, when the target recipe set TGT_RCP_SET has no recipe at a same process step in which the reference recipe set REF_RCP_SET has a fourth recipe, the target script set TGT_SCRT_SET does not include the fourth recipe.

In some example embodiments, one of the operations of FIGS. 12A, 12B and 12C may be performed on each recipe.

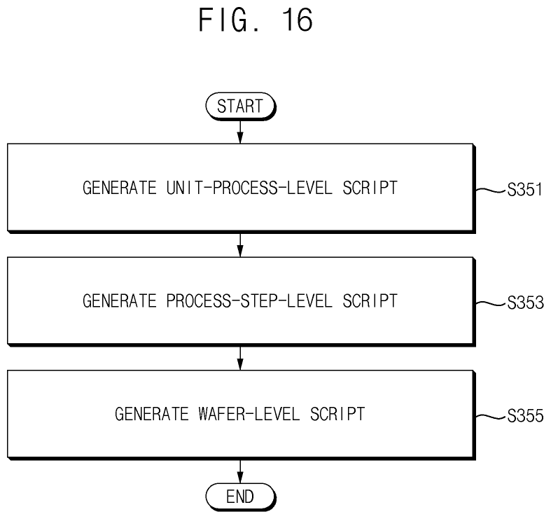

FIGS. 14, 15, 16 and 17 are diagrams illustrating examples of automatically generating a target script set in FIG. 10.

Referring to FIG. 14, wafer information, process step information and unit process description information may be extracted from the target recipe set (operation S330), and the target script set may be automatically generated by applying a rule deck (e.g., various design/checking rules may be applied and/or various verifications may be performed) based on the wafer information, the process step information and the unit process description information (operation S340).

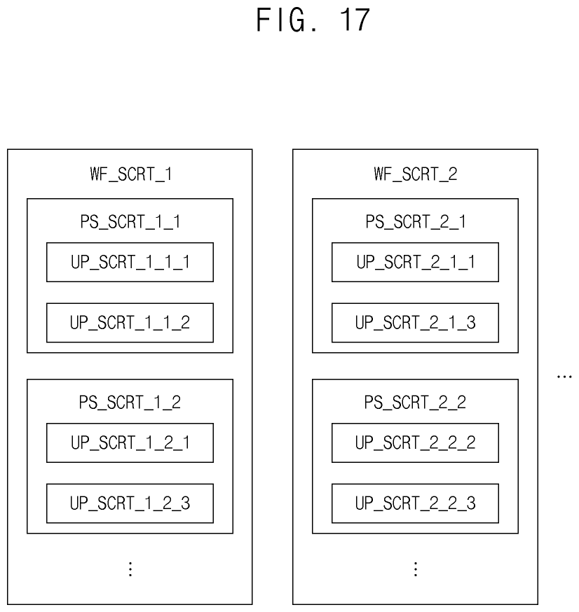

Referring to FIG. 15, when automatically generating the target script set, commands suitable for each process may be automatically generated from the rule deck using the information extracted by operation S330 in FIG. 14.

For example, when a first process PRC1 is present (operation S341a: YES), a script PRC1_SCRT associated with the first process PRC1 may be generated (operation S341b), otherwise (operation S341a: NO), operation S341b may be omitted. For example, when the extracted process is a deposition process, script reflecting unit process description information may be automatically generated based on a basic script of the deposition process from the rule deck. Thereafter, when a second process PRC2 is present (operation S343a: YES), a script PRC2_SCRT associated with the second process PRC2 may be generated (operation S343b), otherwise (operation S343a: NO), operation S343b may be omitted. Similarly, when an X-th process PRCX is present (operation S345a: YES), where X is a natural number greater than or equal to two, a script PRCX_SCRT associated with the X-th process PRCX may be generated (operation S345b), otherwise (operation S345a : NO), operation S345b may be omitted. As described above, the presence or absence of all of the processes PRC1 to PRCX may be sequentially checked, the scripts may be sequentially generated based on a result of checking the processes PRC1 to PRCX, and the target script set may be generated by combining the generated scripts.

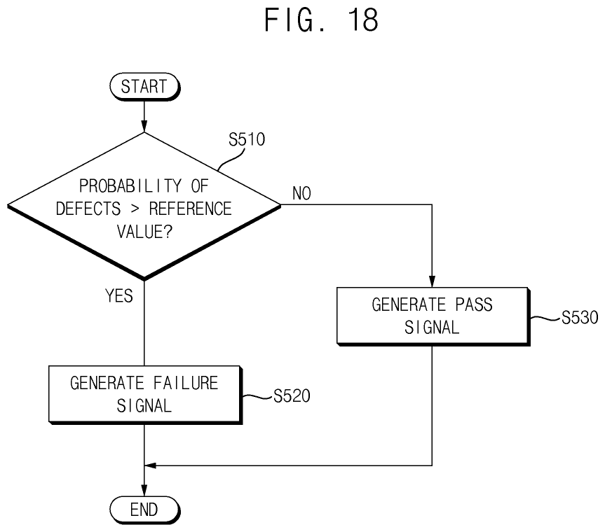

Referring to FIG. 16, when performing the script generation, a unit-process-level script may be generated (operation S351), a process-step-level script may be generated (operation S353), and a wafer-level script may be generated (operation S355). For example, a single process-step-level script may be implemented by generating, removing and/or copying each unit-process-level script, a single wafer-level script may be implemented by combining one or more process-step-level scripts, and the entire target script set may be implemented by combining one or more wafer-level scripts.

In an example embodiment, the processes PRC1 to PRCX in FIG. 15 represent unit processes, and scripts PRC1_SCRT to PRCX_SCRT represent unit-process-level scripts. In this example, each of operations S341b, S343b and S345b in FIG. 15 may correspond to operation S351, performing operations S341b, S343b and S345b in FIG. 15 once may correspond to operation S353, a single process-step-level script may be generated by performing operations S341b, S343b and S345b in FIG. 15 once, and a single wafer-level script may be generated by generating a plurality of process-step-level scripts.

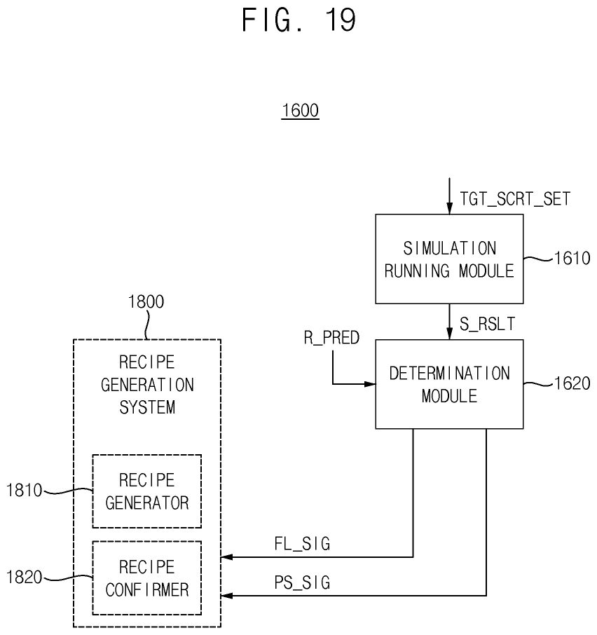

Referring to FIG. 17, the target script set may include at least one wafer-level script, the wafer-level script may include at least one process-step-level script, and the process-step-level script may include at least one unit-process-level script. FIG. 17 illustrates a relationship or hierarchy of wafer-level scripts WF_SCRT_1 and WF_SCRT_2, process-step-level scripts PS_SCRT_1_1, PS_SCRT_1_2, PS_SCRT_2_1 and PS_SCRT_2_2, and unit-process-level scripts UP_SCRT_1_1_1, UP_SCRT_1_1_2, UP_SCRT_1_2_1, UP_SCRT_1_2_3, UP_SCRT_2_1_1, UP_SCRT_2_1_3, UP_SCRT_2_2_2 and UP_SCRT_2_2_3. For example, when experiments (e.g., processes) under different conditions are performed on different wafers, wafer-level scripts the number of which is equal to experimental wafers may be generated.

FIG. 18 is a flowchart illustrating a method of checking a suitability of a target recipe set in FIG. 1 according to an example embodiment.

Referring to FIGS. 1 and 18, in operation S500, when the probability of the defects is greater than a reference value (operation S510: YES), a failure signal indicating that the target recipe set is not suitable for the manufacturing process may be generated (operation S520). When the probability of the defects is less than or equal to the reference value (operation S510: NO), a pass signal indicating that the target recipe set is suitable for the manufacturing process may be generated (operation S530).

FIG. 19 is a block diagram illustrating an example of an automated simulation module included in an automated simulation generation device of FIG. 2.

Referring to FIG. 19, the automated simulation module 1600 may include a simulation running module 1610 and a determination module 1620.

The simulation running module 1610 may simulate the manufacturing process of the semiconductor device when the target recipe set TGT_RCP_SET is to be applied based on the target script set TGT_SCRT_SET, and may output a simulation result signal S_RSLT representing a result of simulating the manufacturing process. In other words, the simulation running module 1610 may perform operation S400 in FIG. 1.

The determination module 1620 may generate a failure signal FL_SIG or a pass signal PS_SIG based on the result of predicting the probability of the defects and the result of simulating the manufacturing process. For example, when the probability of the defects is greater than a reference value, the determination module 1620 may generate the failure signal FL_SIG indicating that the target recipe set TGT_RCP_SET is not suitable for the manufacturing process. When the probability of the defects is less than or equal to the reference value, the determination module 1620 may generate the pass signal PS_SIG indicating that the target recipe set TGT_RCP_SET is suitable for the manufacturing process. In other words, the determination module 1620 may perform operations S510, S520 and S530 in FIG. 18.

In an example embodiment, a result of checking the suitability of the target recipe set TGT_RCP_SET, e.g., the failure signal FL_SIG and/or the pass signal PS_SIG, is output to the recipe generation system 1800. For example, when the failure signal FL_SIG is received, the recipe confirmer 1820 may control the recipe generator 1810 to change the target recipe set TGT_RCP_SET. When the pass signal PS_SIG is received, the recipe confirmer 1820 may cause performance of the manufacturing process of the semiconductor device to which the target recipe set TGT_RCP_SET is applied.

FIGS. 20, 21, 22 and 23 are flowcharts illustrating an automated simulation method according to example embodiments. The descriptions repeated with FIG. 1 will be omitted for brevity.

Referring to FIG. 20, in an automated simulation method according to an example embodiment, operations S100, S200, S300, S400 and S500 may be substantially the same as those described with reference to FIG. 1.

When it is determined that the target recipe set is not suitable for the manufacturing process (operation S1100: NO), e.g., when operation S520 in FIG. 18 is performed and the failure signal is generated, the target recipe set may be changed, and a suitability of the changed target recipe set may be checked again (operation S1200). For example, the changed target recipe set may be received from the recipe generation system 1800 in FIG. 2, and operations similar to operations S100, S200, S300, S400 and S500 may be performed again based on the changed target recipe set.

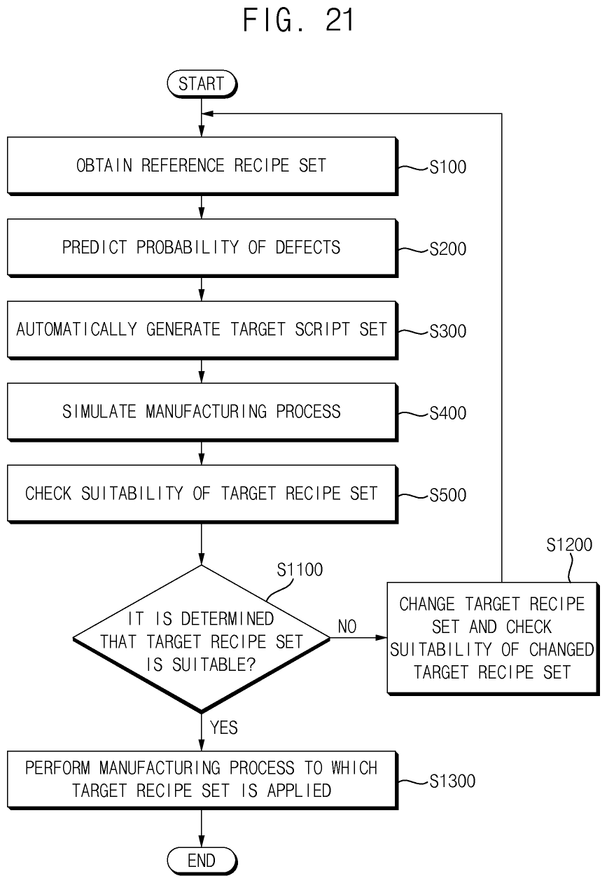

Referring to FIG. 21, in an automated simulation method according to example embodiments, operations S100, S200, S300, S400 and S500 may be substantially the same as those described with reference to FIG. 1, and operations S1100 and S1200 may be substantially the same as those described with reference to FIG. 20.

When it is determined that the target recipe set is suitable for the manufacturing process (operation S1100: YES), e.g., when operation S530 in FIG. 18 is performed and the pass signal is generated, the semiconductor device may be fabricated or manufactured by performing the manufacturing process to which the target recipe set is applied (operation S1300).

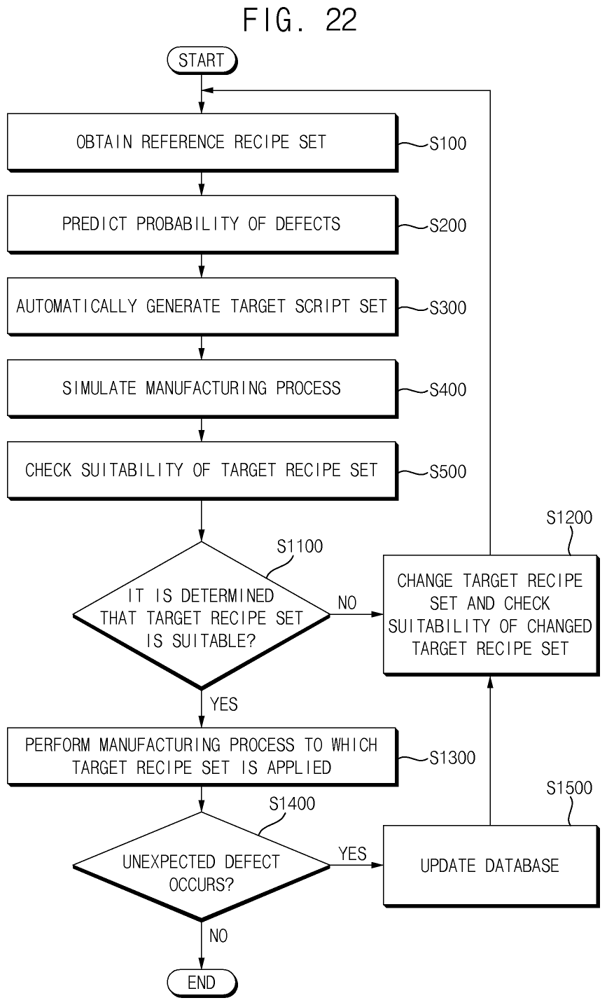

Referring to FIG. 22, in an automated simulation method according to example embodiments, operations S100, S200, S300, S400 and S500 may be substantially the same as those described with reference to FIG. 1, operations S1100 and S1200 may be substantially the same as those described with reference to FIG. 20, and operation S1300 may be substantially the same as that described with reference to FIG. 21.

When it is determined that the target recipe set is suitable for the manufacturing process (operation S1100: YES) and the manufacturing process to which the target recipe set is applied is performed (operation S1300), and when an unexpected defect (e.g., real defect) occurs in the manufacturing process to which the target recipe set is applied (operation S1400: YES), the database may be updated based on a result of the unexpected defect occurring (operation S1500). For example, data (e.g., the target deep learning model, the target script set, etc.), which are associated with the target recipe set and are stored in the database, may be updated, and thus the accuracy of the future simulation may be increased.

In some example embodiments, when the unexpected defect occurs in the manufacturing process to which the target recipe set is applied, it may mean that the result of simulating the manufacturing process is inappropriate, and thus operation S1200 may be performed after operation S1500 to change the target recipe set and to check the suitability of the changed target recipe set again.

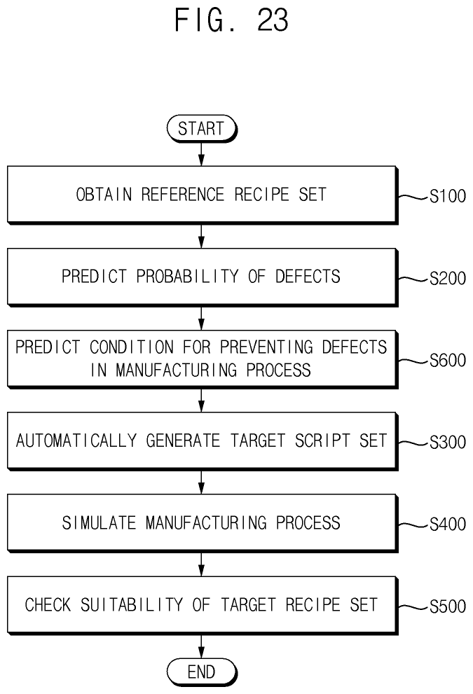

In some example embodiments, the automated simulation method of FIGS. 22 and 23 may be described as a manufacturing method of a semiconductor device.

Referring to FIG. 23, in an automated simulation method according to example embodiments, operations S100, S200, S300, S400 and S500 may be substantially the same as those described with reference to FIG. 1.

After operation S200, a condition for preventing the defects in the manufacturing process of the semiconductor device when the target recipe set is to be applied to the manufacturing process may be predicted by performing the deep learning based on the database, the target recipe set and the reference recipe set (operation S600). In addition, to simplify predicting the probability of the defects (or the probability of the occurrence of the defects), the condition under which no defect occurs in relation to the target recipe set may be predicted and proposed. Therefore, a guide for preventing the defects may be additionally provided.

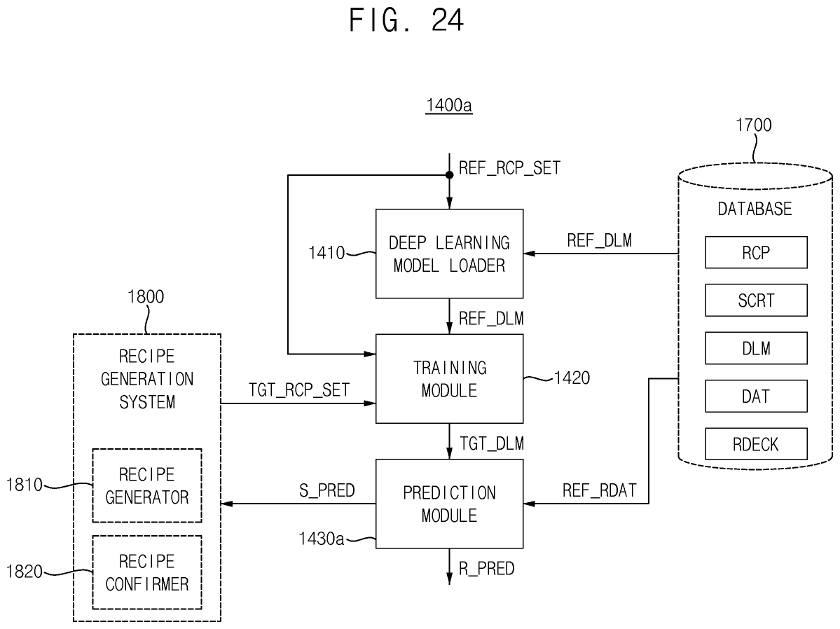

FIG. 24 is a block diagram illustrating an example of a deep learning module included in an automated simulation generation device of FIG. 2. The descriptions repeated with FIG. 8 will be omitted for brevity.

Referring to FIG. 24, a deep learning module 1400a may include a deep learning model loader 1410, a training module 1420 and a prediction module 1430a.

The deep learning module 1400a may be substantially the same as the deep learning module 1400a of FIG. 8, except that an operation of the prediction module 1430a is partially changed.

The prediction module 1430a may further predict a condition for preventing the defects in the manufacturing process when the target recipe set TGT_RCP_SET is to be applied to the manufacturing process, and may output a prediction result signal S_PRED representing a result of predicting the condition for preventing the defects. In other words, the prediction module 1430a may perform operation S600 in FIG. 24. The result of predicting the condition for preventing the defects may be output to the recipe generation system 1800, and may be used to change the target recipe set TGT_RCP_SET.

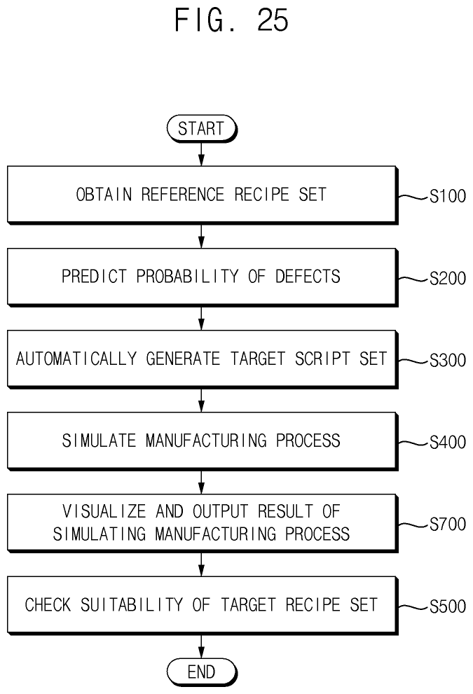

FIG. 25 is a flowchart illustrating an automated simulation method according to an example embodiment. The descriptions repeated with FIG. 1 will be omitted for brevity.

Referring to FIG. 25, in an automated simulation method according to example embodiments, operations S100, S200, S300, S400 and S500 may be substantially the same as those described with reference to FIG. 1.

After operation S400, the result of simulating the manufacturing process may be visualized and output (operation S700). For example, the result may be presented on a display device. The recipe-based simulation results that are automatically generated and the visualized simulation results may be provided together, and thus the semiconductor device design may be implemented.

In some example embodiments, the automated simulation method according to example embodiments may be implemented by combining two or more of the methods of FIGS. 20, 21, 22, 23 and 25.

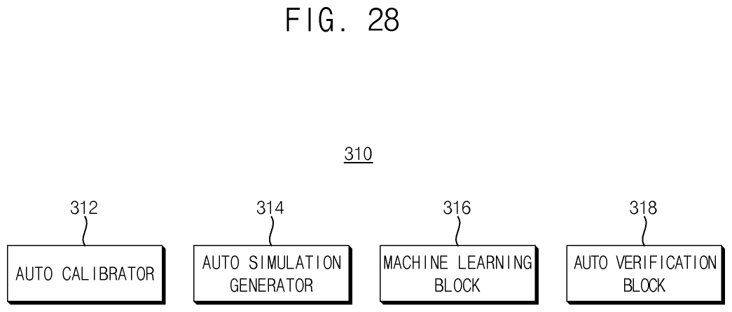

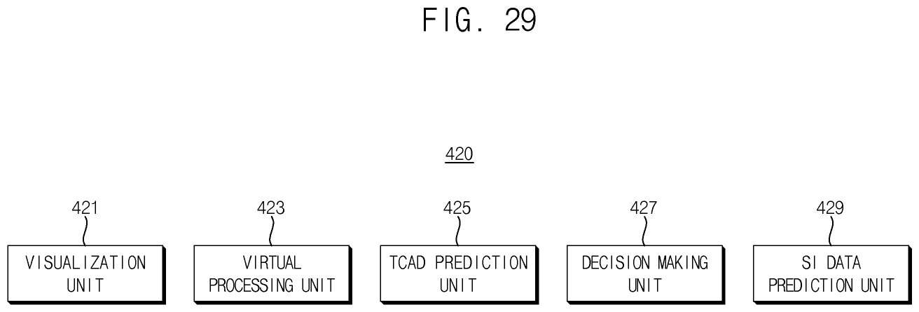

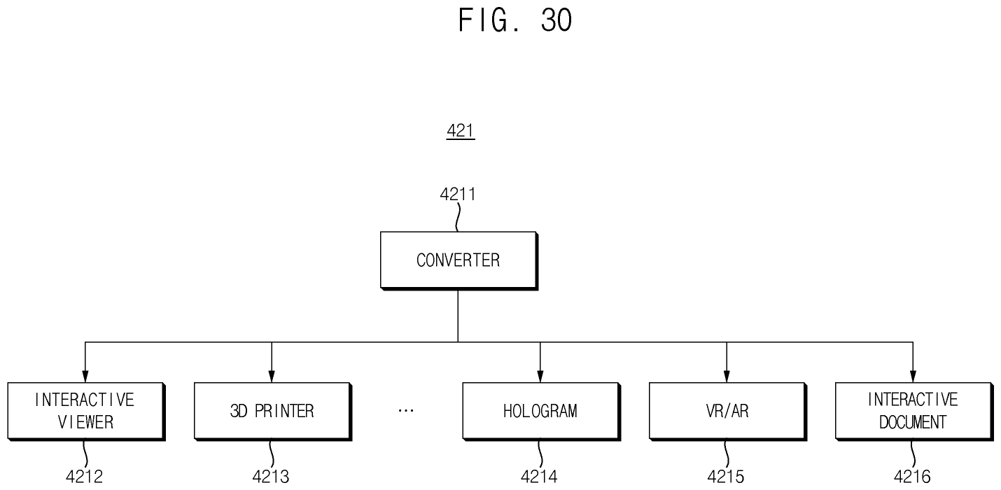

FIGS. 26 and 27 are block diagrams illustrating a semiconductor design automation system according to example embodiments. FIGS. 28 and 29 are diagrams illustrating an example of first and second graphic user interfaces included in a semiconductor design automation system of FIG. 27. FIG. 30 is a block diagram illustrating an example of a visualization unit included in a second graphic user interface of FIG. 29.

Referring to FIGS. 26, 27, 28, 29 and 30, a semiconductor design automation system includes an automation module 100, a database 200 (also referred to as a technology database), an adjustment (or consistency) maintain module 300, and a virtualization visualization module 400, for output to a user 500.

In some example embodiments, a semiconductor device automatically designed by the semiconductor design automation system 10 may be, e.g., a FinFET semiconductor device, a DRAM semiconductor device, a NAND semiconductor device, a vertical NAND (VNAND) semiconductor device, or the like. However, these are merely examples, and the semiconductor device is not limited thereto.

The automation module 100 may include a simulator 110 (also referred to as a TCAD simulator), a recovery module 120 (also referred to as a failure recovery module), a parser 130, a hardware (HW) data module 140, a pre-processing module 150, and a data loader 160.

The simulator 110 may perform a semiconductor device modeling. The semiconductor device modeling may be performed using, e.g., a TCAD. For example, the semiconductor device modeling may use at least one of a process TCAD in which a semiconductor device manufacturing process is modeled and a device TCAD in which an operation of the semiconductor device is modeled. For example, a TCAD tool for performing TCAD may be Synopsys, Silvaco, Crosslight, Cogenda Software|VisualTCAD, Global TCAD Solutions, Tiberlab, or the like.

The recovery module 120 may automatically recover errors of simulation data (e.g., a plurality of samples) generated by the simulator 110. For example, the recovery module 120 may correct or otherwise recover the errors of the plurality of samples generated by the simulator 110 using log, status analysis, or the like, and may transfer the recovery simulation data to the parser 130 or the simulator 110.

The parser 130 may receive the recovery simulation data (e.g., the plurality of samples in which the errors are recovered) from the recovery module 120, and may perform parsing on the recovery simulation data. The parser 130 may be replaced with a compiler for performing a compiling on the recovery simulation data. The parser 130 may be part of the compiler.

The hardware data module 140 may collect the real data associated with the actually manufactured semiconductor device. For example, the real data may be generated and/or measured from the manufactured device. The pre-processing module 150 may pre-process the real data received from the hardware data module 140 into a format that may be utilized by simulation. The data loader 160 may store the pre-processed real data, and may periodically transmit the stored real data to the database 200.

The database 200 may store the simulation data and the real data. For example, the database 200 may store the recovery simulation data, may store the processing data and/or the measured data during an actual manufacturing process, and may store specification or standard related data.

The database 200 may correspond to the database 1700 in FIG. 2, which is used for the operation of the automated simulation generation device 1000 according to example embodiments.

The adjustment maintain module 300 may include a first graphic (or graphical) user interface (GUI) 310, a simulation deck 320, a TCAD block 330, and a silicon (Si) model block 340.

As shown in FIG. 28, the first graphic user interface 310 may include an automatic calibrator 312, an automatic simulation generator 314, a machine learning block 316, and an automatic verification block 318.

The automatic calibrator 312 may compare the real data with the simulation data loaded in the database 200 using an automatic calibration function to maintain consistency or compatibility between the real data and the simulation data. The automatic simulation generator 314 may generate a machine learning model based on the recovery simulation data and the pre-processed real data, and may generate predicted real data from the machine learning model. The machine learning block 316 may perform machine learning using the pre-processed data. The automatic verification block 318 may maintain the consistency or compatibility between the real data and the predicted real data generated by the automatic simulation generator 314.

The automatic simulation generator 314 may correspond to the automated simulation generation device 1000 according to example embodiments.

The simulation deck 320 may store the predicted real data generated by the automatic simulation generator 314. The TCAD block 330 may store the data subjected to the machine learning based on the simulation data. The silicon model block 340 may store the data subjected to the machine learning based on the real data.

The virtualization visualization module 400 may include a decision block 410 and a second graphic user interface (GUI) 420.

The decision block 410 may receive the data subjected to the machine learning based on the simulation data from the TCAD block 330, may receive the data subjected to the machine learning based on the real data from the silicon model block 340, and may store the received data.

As shown in FIG. 29, the second graphic user interface 420 may include a visualization unit 421, a virtual processing unit 423, a TCAD prediction unit 425, a decision making unit 427, and a silicon (SI) data prediction unit 429.

As shown in FIG. 30, the visualization unit 421 may include a converter 4211, an interactive viewer 4212, a 3D printer 4213, a hologram device 4214, a virtual reality/augmented reality (VR/AR) device 4215, an interactive document 4216, or the like. The visualization unit 421 may generate predicted real data and a visualized virtualization process result from the machine learning model. For example, the visualization unit 421 may perform operation S700 in FIG. 25.

The virtual processing unit 423 may perform a virtualization process using the predicted real data stored in the simulation deck 320, which was generated by the automatic simulation generator 314 from the data stored in the database 200. The TCAD prediction unit 425 may perform a TCAD simulation based on the data subjected to the machine learning based on the simulation data using the TCAD block 330 to perform a prediction simulation for the semiconductor device. The decision making unit 427 may determine simulation target data using the data subjected to the machine learning based on the simulation data which is received from the TCAD block 330 and stored in the decision block 410, and the data subjected to the machine learning based on the real data which is received from the silicon model block 340 and stored in the decision block 410. The silicon data prediction unit 429 may perform an actual semiconductor process based on the data subjected to the machine learning based on the real data stored in the silicon model block 340. For example, performing the semiconductor process may result in fabrication of a semiconductor device.

The automated simulation method according to example embodiments may be implemented in conjunction with or interoperable with the automatic simulation generator 314 included in the first graphic user interface 310, the simulation deck 320, and the visualization unit 421 and the virtual processing unit 423 that are included in the second graphic user interface 420.

In some example embodiments, the semiconductor design automation system 10 may be implemented as illustrated in FIG. 3. For example, all of the automation module 100, the adjustment maintain module 300 and the virtualization visualization module 400 may be implemented in software, and the program PR in FIG. 3 may correspond to the automation module 100, the adjustment maintain module 300 and the virtualization visualization module 400.

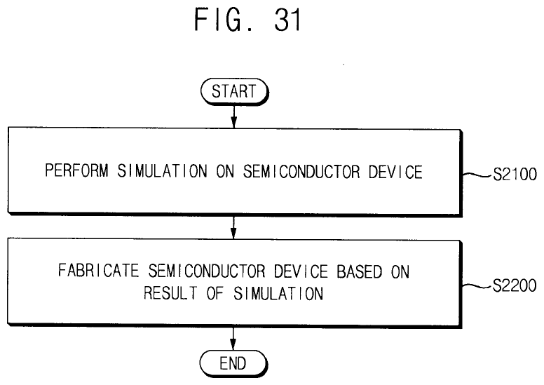

FIG. 31 is a flowchart illustrating a manufacturing method of a semiconductor device according to an example embodiment.

Referring to FIG. 31, in a method of manufacturing a semiconductor device according to an example embodiment, a simulation is performed on the semiconductor device (operation S2100), and the semiconductor device is fabricated based on a result of the simulation on the semiconductor device (operation S2200). In other words, a simulation method associated with the semiconductor device is performed, and the semiconductor device is fabricated based on a result of performing the simulation method. The simulation in operation S2100 may represent the simulation using the target recipe set associated with the manufacturing process of the semiconductor device, and operation S2100 may be performed based on the automated simulation method according to example embodiments described with reference to FIGS. 1 through 25.

In operation S2200, the semiconductor device may be fabricated or manufactured by a mask, a wafer, a test, an assembly, packaging, and the like. For example, a corrected layout may be generated by performing optical proximity correction on the design layout, and a photo mask may be fabricated or manufactured based on the corrected layout. For example, various types of exposure and etching processes may be repeatedly performed using the photo mask, and patterns corresponding to the layout design may be sequentially formed on a substrate through these processes. Thereafter, the semiconductor device may be obtained in the form of a semiconductor chip through various additional processes.

The inventive concept may be applied to design various electronic devices and systems that include the semiconductor devices and the semiconductor integrated circuits. For example, the inventive concept may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1. A non-transitory computer readable medium storing program code for determining suitability of a target receipe set for manufacturing a semiconductor device, the program code, when executed by a processor, causing the processor to:
obtain a reference recipe set by searching a database based on the target recipe set, the reference recipe set having a similarity within a threshold to the target recipe set;
perform deep learning based on the database, the target recipe set and the reference recipe set to predict a probability of a defect occurring in the semiconductor device when manufactured using a manufacturing process based on the target receipe set;
generate a target script set corresponding to the target recipe set by comparing the target recipe set with the reference recipe set;
simulate the manufacturing process of the semiconductor device using the target script set; and
determine the suitability of the target recipe set based on the probability of the defect and a result of the simulate of the manufacturing process.

2. The non-transitory computer readable medium of claim 1, wherein the obtain of the reference recipe set comprises:
perform a similarity analysis on the target recipe set with a plurality of recipe sets stored in the database; and
select one of the plurality of recipe sets from the database as the reference recipe set based on a result of the performing of the similarity analysis.

3. The non-transitory computer readable medium of claim 2, wherein:
the plurality of recipe sets and the reference recipe set that are stored in the database are recipe sets that have been previously been applied to the manufacturing process of the semiconductor device, and
the target recipe set is a recipe set that has not yet been applied to the manufacturing process of the semiconductor device.

4. The non-transitory computer readable medium of claim 1, wherein the predict of the probability of the defect comprises:
load a reference deep learning model corresponding to the reference recipe set among a plurality of deep learning models from the database;
generate target deep learning model corresponding to the target recipe set based on the target recipe set, the reference recipe set and the reference deep learning model; and
calculate the probability of the defect based on the target deep learning model and a result of performing the manufacturing process of the semiconductor device using the reference recipe set.

5. The non-transitory computer readable medium of claim 4, wherein:
the target recipe set includes a plurality of target recipes,
the reference recipe set includes a plurality of reference recipes, and
the target deep learning model is generated by comparing conditions and an order of the plurality of target recipes with conditions and an order of the plurality of reference recipes, by identifying a difference between the target recipe set and the reference recipe set based on a result of comparing the plurality of target recipes with the plurality of reference recipes, and by performing a transfer learning or re-learning on the reference deep learning model.

6. The non-transitory computer readable medium of claim 1, wherein the generate of the target script set comprises:
compare conditions and an order of a plurality of target recipes with conditions and an order of a plurality of reference recipes, the plurality of target recipes being included in the target recipe set, the plurality of reference recipes being included in the reference recipe set; and
obtain the target script set including a plurality of target scripts by performing at least one of a script copy, a script removal and a script generation based on a result of comparing the plurality of target recipes with the plurality of reference recipes, the plurality of target scripts corresponding to the plurality of target recipes.

7. The non-transitory computer readable medium of claim 6, wherein the obtain of the target script set comprises:
in response to a first target recipe being identical to a first reference recipe among the plurality of reference recipes being included in the plurality of target recipes, perform the script copy such that a first target script corresponding to the first target recipe is provided to the target script set.

8. The non-transitory computer readable medium of claim 6, wherein the obtain of the target script set comprises:
in response to a first target recipe identical to a first reference recipe among the plurality of reference recipes being not included in the plurality of target recipes, perform the script removal such that a first target script corresponding to the first target recipe is not provided to the target script set.

9. The non-transitory computer readable medium of claim 6, wherein the obtain of the target script set comprises:
in response to a first reference recipe identical to a first target recipe among the plurality of target recipes being not included in the plurality of reference recipes, performing the script generation such that a first target script corresponding to the first target recipe is provided to the target script set.

10. The non-transitory computer readable medium of claim 6, wherein the generate of the target script set includes extracting wafer information, process step information and unit process description information from the target recipe set, and by applying a rule deck based on the wafer information, the process step information and the unit process description information.

11. The non-transitory computer readable medium of claim 10, wherein:
the target script set includes at least one wafer-level script,
the wafer-level script includes at least one process-step-level script, and
the process-step-level script includes at least one unit-process-level script.

12. The non-transitory computer readable medium of claim 1, wherein the determine of the suitability of the target recipe set comprises:
in response to the probability of the defect being greater than a reference value, generating a failure signal representing that the target recipe set is not suitable for the manufacturing process; and
in response to the probability of the defect being less than or equal to the reference value, generating a pass signal representing that the target recipe set is suitable for the manufacturing process.

13. The non-transitory computer readable medium of claim 12, wherein, in response to determining that the target recipe set is suitable and the pass signal being generated, the semiconductor device is fabricated by performing the manufacturing process using the target recipe set.

14. The non-transitory computer readable medium of claim 13, wherein, in response to determining that the target recipe set is suitable and the manufacturing process being performed using the target recipe set, and in response to a defect occurring in the manufacturing process using the target recipe set, the database is updated to indicate an unexpected defect has occurred using the target recipe set.

15. The non-transitory computer readable medium of claim 13, wherein, in response to determining that the target recipe set is suitable and the manufacturing process being performed using the target recipe set, and in response to a defect occurring in the manufacturing process using the target recipe set, the target recipe set is changed and a suitability of the changed target recipe set is determined.

16. The non-transitory computer readable medium of claim 1, where the program code, when executed by the processor, further causes the processor to:
predict a condition for preventing the defect from occurring in the semiconductor device when the manufacturing process of the semiconductor device is performed using the target recipe set, the condition being predicted by performing the deep learning based on the database, the target recipe set and the reference recipe set.

17. The non-transitory computer readable medium of claim 1, where the program code, when executed by the processor, further causes the processor to:
present a result of the simulate of the manufacturing process on a display device.

18. An automated simulation generation device for determining suitability of a target recipe set for manufacturing a semiconductor device, the automated simulation generation device comprising:
a processor; and
a memory storing a computer program for execution by the processor,
wherein the computer program:
obtains a reference recipe set by searching a database based on the target recipe set, the reference recipe set having a similarity within a threshold to the target recipe set;
performs a deep learning based on the database, the target recipe set and the reference recipe set to predict a probability of a defect occurring in the semiconductor device when manufactured using a manufacturing process based on the target receipe set;
generates a target script set corresponding to the target recipe set by comparing the target recipe set with the reference recipe set;
simulates the manufacturing process of the semiconductor device using the target script set; and
determines the suitability of the target recipe set based on the probability of the defect and a result of the simulates of the manufacturing process.

19. The device of claim 18, wherein:
the target recipe set is received from an external system located outside the device, and
a result of the determine of the suitability of the target recipe set is output to the external system.

20. (canceled)

21. A system for automatically designing a semiconductor device, the system comprising:
a database; and
an automated simulation generation device configured to simulate manufacturing of the semiconductor device using the database,
wherein the automated simulation generation device comprises:
a processor; and
a memory storing a computer program for execution by the processor,
wherein the computer program:
obtains a reference recipe set by searching a database based on the target recipe set, the reference recipe set having a similarity within a threshold to the target recipe set;
performs a deep learning based on the database, the target recipe set and the reference recipe set to predict a probability of a defect occurring in the semiconductor device when manufactured using a manufacturing process based on the target receipe set;
generates a target script set corresponding to the target recipe set by comparing the target recipe set with the reference recipe set;
simulates the manufacturing process of the semiconductor device using the target script set; and
determines a suitability of the target recipe set based on the probability of the defect and a result of the simulates of the manufacturing process.

22. (canceled)
